(19) United States
(12) Patent Application Publication
(10) Pub. No.: US 2026/0312611 A1
(43) Pub. Date: Oct. 8, 2026

(54) SIGNAL RECEIVER INCLUDING A FEED FORWARD EQUALIZER, METHOD OF OPERATION THEREOF, AND ELECTRONIC SYSTEM INCLUDING THE SAME

(71) Applicant: Samsung Electronics Co., Ltd., Suwon-si (KR)

(72) Inventors: Jejoong WOO, Suwon-si (KR); Jaewoo PARK, Suwon-si (KR); Myoungbo KWAK, Suwon-si (KR); Hyoungbae AHN, Suwon-si (KR); Ilsoo LEE, Suwon-si (KR)

(21) Appl. No.: 19/433,356

(22) Filed: Dec. 26, 2025

(30) Foreign Application Priority Data
Apr. 2, 2025 (KR) 10-2025-0043017

(51) Int. Cl. H04B 1/16; H04B 1/00; H04B 17/336

(52) U.S. Cl. CPC H04B 1/16; H04B 1/0007; H04B 17/336

(57) ABSTRACT

An example signal receiver according to the present disclosure comprises an analog-to-digital conversion circuit configured to perform digital sampling on a amplified signal to generate a plurality of analog-to-digital conversion signals, a feed forward equalization circuit including a plurality of feed forward equalizers configured to perform feed forward equalization on the plurality of analog-to-digital conversion signals to generate feed forward equalization signals, and a masking bit control circuit configured to generate a first masking bit control signal associated with the feed forward equalization, where a first feed forward equalizer of the plurality of feed-forward equalizers is configured to generate a plurality first tap output signals, and adjust a digital value of each of the plurality of first tap output signals to generate the first masking signals based on the first masking bit control signals.

### CROSS-REFERENCE TO RELATED APPLICATION

This application claims priority under 35 U.S.C. § 119 to Korean Patent Application No. 10-2025-0043017 filed on April 2, 2025, in the Korean Intellectual Property Office, the disclosures of which are incorporated by reference herein in their entireties.

### BACKGROUND

Electronic devices exchange information by transmitting electrical signals with other electronic devices through a channel (e.g., a signal line). In signals transmitted and received between electronic devices, signal distortion occurs due to a response characteristic of a channel. In order to compensate for such signal distortion, various types of equalizers are used.

For example, to compensate for signal distortion, the receiving end includes a feed forward equalizer. The feed forward equalizer includes a plurality of arithmetic circuits for removing inter-symbol interference. Accordingly, most of the power used at the receiver is consumed at the feed forward equalizer. With the rapid increase in data throughput of electronic devices due to the recent rise of the AI industry, it is desired to reduce power consumption of the feed forward equalizer.

### SUMMARY

The present disclosure relates to a signal receiver having improved performance, a method of operating the same, and an electronic system comprising the same.

In some implementations, a signal receiver includes an analog front-end circuit configured to perform an amplification operation on a received signal from external device to generate an amplified signal, an analog-to-digital conversion circuit configured to perform digital sampling on the amplified signal to generate a plurality of analog-to-digital conversion signals, a feed forward equalization circuit including a plurality of feed forward equalizers configured to perform feed forward equalization on the plurality of analog-to-digital conversion signals to generate a plurality of feed forward equalization signals, and a masking bit control circuit configured to generate a first masking bit control signal associated with the feed forward equalization, where the plurality of feed forward equalizers include a first feed forward equalizer configured to generate a plurality first tap output signals based on first analog-to-digital convert signals of the analog-to-digital conversion signals among the plurality of analog-to-digital conversion signals, adjust a digital value of each of the plurality of first tap output signals to generate a first plurality of masking signals based on the first masking bit controls signal, and generate a first feed forward equivalent signal of the plurality of feed forward equalization signals based on the first masking signals.

In some implementations, a method of operating a receiver including a masking bit control circuit and an equalizer circuit includes generating, by the equalizer circuit, a plurality of tap output signals by reflecting feed-forward equalization coefficients respectively corresponding to the plurality of digital signals in a plurality of digital signals; adjusting, by the equalizer circuit, a logic value of at least one bit of bits of the plurality of tap output signal based on the masking bit control signal received from the masking bit controlling circuit to generate a plurality of masking signals, performing, by the equalizer circuit, an addition operation on the plurality of masking signal to generate a plurality the computation signals, and generating, by the equalizer circuit, a plurality the feed-forward equalization signals based on the plurality of computation signals.

In some implementations, an electronic system comprises a first electronic device and a second electronic device, where the first electronic device is configured to communicate with the second electronic device, and comprises a communication module comprising a transmitter and a receiver, where the receiver comprises an analog front-end circuit configured to perform an amplification operation on a received signal received from the second electronic device to generate an amplified signal, an analog-to-digital conversion circuit configured to perform digital sampling on the amplified signal to generate a plurality of analog-to-digital conversion signals, a feed forward equalizer circuit configured to perform feed forward equalization (FFE) on the plurality of analog- to-digital conversion signals to generate a plurality of feed forward equalization signals, and a masking bit control circuit configured to generate a masking bit control signal including information about a number of masking bits based on the feed forward equalization signal, where the feed forward equalizer circuit comprises a first feed forward equalizer configured to generate a first feed forward equalization signal of the plurality of feed forward equalization signals based on a plurality of first digital signals among the plurality of digital signals, and comprises a plurality of multipliers configured to generate a plurality first tap output signals based on the first digital signals and feed forward equalization coefficients respectively corresponding to the first digital signals, a first masking circuit configured to adjust a digital value of each of the plurality of first tap output signals to generate a plurality of first masking signals based on the number of masking bits, and a first adder configured to perform an addition operation on the plurality of first masking signals to generate a first computation signal.

### BRIEF DESCRIPTION OF THE DRAWINGS

The above and other objects and features of the present disclosure will become apparent by describing in detail implementations thereof with reference to the accompanying drawings.

FIG. 1 is a block diagram illustrating an example of an electronic system.

FIG. 2 is an example block diagram for describing the first receiver of FIG. 1.

FIG. 3 is an example block diagram for describing the analog-to-digital conversion circuit of FIG. 2.

FIG. 4 is an example block diagram for describing the equalizer circuit and the masking bit control circuit of FIG. 2.

FIG. 5 is an example block diagram illustrating the feed forward equalization circuit of FIG. 4.

FIG. 6 is a flowchart for describing an example of an operation method of the feed forward equalization circuit of FIG. 5.

FIG. 7 is an example diagram for describing the feed forward equalizer of FIG. 5.

FIGS. 8A, 8B, 8C, 8D, and 8E are diagrams for describing an example of a masking operation of the FFE masking circuit of FIG. 7.

FIG. 9 is a flowchart for describing an example of an operation method of the first receiver of FIG. 2.

FIG. 10 is an example flowchart for describing step S240 of FIG. 9.

FIG. 11 is an example flowchart for describing step S244 of FIG. 10.

FIG. 12 is an example diagram for describing step S243 of FIG. 10 and step S244c of FIG. 11.

FIG. 13 is a flowchart for describing an example of step S240 of FIG. 9.

FIG. 14 is an example diagram for describing step S247 of FIG. 13.

FIG. 15 is a block diagram illustrating an example of the equalizer circuit and the masking bit control circuit of FIG. 2.

FIG. 16 is an example block diagram for describing the decision feedback equalization circuit of FIG. 15.

FIG. 17 is an example diagram for describing the decision feedback equalizer of FIG. 16.

FIG. 18 is a block diagram illustrating an example of the equalizer circuit and the masking bit control circuit of FIG. 2.

FIG. 19 is a block diagram illustrating an example of a system.

FIG. 20 is a block diagram illustrating an example of a host-storage system.

### DETAILED DESCRIPTION

In the following, implementations of the present disclosure will be described clearly and in detail to the extent that a person skilled in the art can easily practice the present disclosure.

Terms such as “block”, “unit”, “logic” and the like used in the detailed description, or functional blocks shown in the drawings to correspond thereto, may be implemented in the form of software, hardware, and/or a combination thereof.

In the following, where various components are listed via the conjunction of “or” this may refer to each of the listed components, or to a combination of at least some. For example, “A, B, or C” can mean each of A, B, and C, or a combination of A and B, a combination of B and C, a combination of A, and C, and/or a combination of A, B and C.

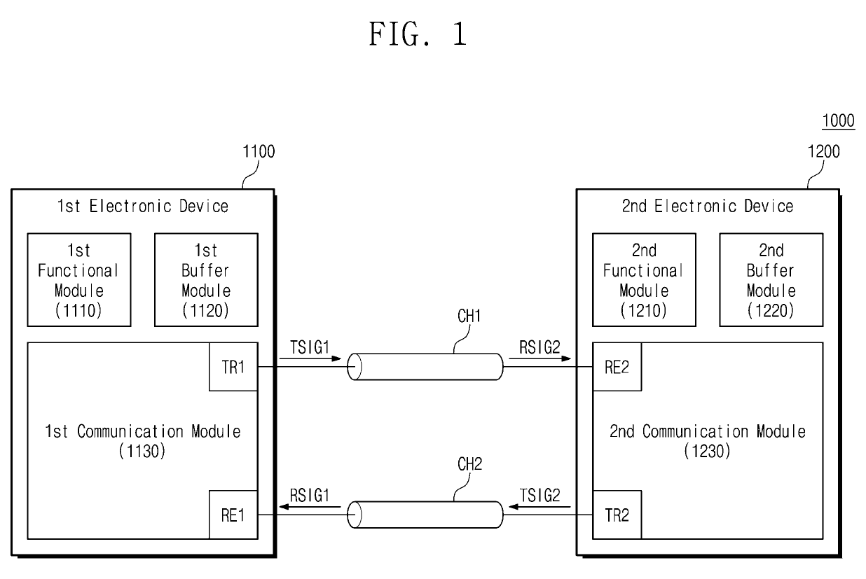

FIG. 1 is a block diagram illustrating an example of an electronic system. Referring to FIG. 1, an electronic system 1000 may include a first electronic device 1100 and a second electronic device 1200.

The first electronic device 1100 and the second electronic device 1200 may be electronic devices configured to perform various functions. For example, the first electronic device 1100 and the second electronic device 1200 may be a computer, a laptop computer, a tablet computer, a personal digital assistant (PDA), a camera, an electronic control unit (ECU), a storage device, a memory device, a datacenter, or the like. For example, the electronic system 1000 may be a storage system, the first electronic device 1100 may be a host, and the second electronic device 1200 may be a storage device.

The first electronic device 1100 may include a first functional module 1110, a first buffer module 1120, and a first communication module 1130, and the first communication module 1130 may include a first transmitter TR1 and a first receiver RE1. The second electronic device 1200 may include a second functional module 1210, a second buffer module 1220, and a second communication module 1230, and the second communication module 1230 may include a second transmitter TR2 and a second receiver RE2. Hereinafter, respective configurations are described with reference to the first electronic device 1100, and corresponding respective configurations of the second electronic device 1200 may be the same as or similar to the corresponding configurations of the first electronic devices 1100 and may operate the same as or similarly to the operations of the corresponding respective configuration of the first electronic device 1100.

The first functional module 1110 may control overall operations of the first electronic device 1100. In some implementations, the first functional module 1110 may include at least one processor. For example, the first functional module 1110 may include a central processing unit (CPU), and may further include an accelerator such as a graphics processing unit (GPU), a neural processing unit (NPU), or the like.

In some implementations, the first functional module 1110 may cause the first electronic device 1100 to perform various operations. For example, the first functional module 1110 may execute a source code or a program stored in the first buffer module 1120, so that the first electronic device 1100 performs an operation indicated by the source code or the program. In some implementations, the first functional module 1110 may further include configurations required for a functions or operations of the first electronic device 1100. For example, when the first electronic device 1100 is a camera, the first function module 1110 may further include a lens, a CIS sensor, or the like required for the operations of the first electronic device. For another example, the first electronic device 1100 may further include a user interface for providing information to the user or receiving an input from the user.

The first buffer module 1120 may store data required or necessary for operation of the first electronic device 1100. For example, the first buffer module 1120 may store source code necessary for operation of the first electronic device 1100, or data necessary for execution of the source code. In some implementations, the first buffer module 1120 may include at least one memory device or storage device. For example, the first buffer module 1120 may include at least one a volatile memory device such as a static random-access memory (SRAM) or a dynamic RAM (DRAM), or a non-volatile memory device.

The first communication module 1130 may perform communication between electronic devices. In some implementations, the first communication module 1130 may support wired communication. For example, the first communication module 1130 may cause wired communication between the first electronic device 1100 and other electronic devices (e.g., the second electronic device 1200) to be performed.

The first transmitter TR1 may transmit data to other electronic devices. In some implementations, the first transmitter TR1 may transmit data in a symbol form. In some implementations, the transmission signal transmitted by the first transmitter TR1 may include at least one symbol. For example, the first transmitter TR1 may transmit a first transmission signal TSIG1 to the second electronic device 1200 through a first channel CH1.

In some implementations, the first transmitter TR1 may generate the first transmission signal TSIG1 based on control or data received from the first functional module 1110 or the first buffer module 1120. For example, the first transmitter TR1 may generate a plurality of symbols based on the data received from the functional module 1110 or the first buffer module 1120. The first transmitter TR1 may generate the first transmission signal TSIG1 including the plurality of symbols. In some implementations, the first transmitter TR1 may transmit the first transmission signal TSIG1 to other electronic devices (e.g., the second electronic device 1200). In some implementations, the first transmitter TR1 may include a serializer. In some implementations, the first transmitter TR1 may generate the first transmission signal TSIG1 based on data received from the serializer.

The first receiver RE1 may receive a first received signal RSIG1. The first received signal RSIG1 may be a signal generated by a transmission signal of another electronic device passing through channels. For example, the first received signal RSIG1 may be a signal generated by a second transmission signal TSIG2 transmitted by the second electronic device 1200 passing through a second channel CH2. In some implementations, the first received signal RSIG1 may include a plurality of symbols. In some implementations, the first receiver RE1 may generate data based on at least one symbol included in the first received signal RSIG1. For example, the first receiver RE1 may receive the first received signal RSIG1 generated based on the second transmission signal TSIG2 transmitted by the second electronic device 1200, and generate data included in or indicated by the symbols included in the first received signal RSIG1. In some implementations, the first receiver RE1 may transmit the data generated based on the first received signal RSIG1 to the first function module 1110 or the first buffer module 1120.

In some implementations, a form of at least one symbol included in the transmission signals TSIG1 and TSIG2 may be different according to a data coding scheme of the electronic system 1000, the electronic device 1100, or the transmitters TR1 and TR2. For example, symbols included in the transmission signals TSIG1 and TSIG2 may be generated from data based on a pulse code modulation (PCM) scheme. For another example, symbols included in the transmission signals TSIG1 and TSIG2 may be generated from data based on a pulse width modulation (PWM) scheme. For example, at least one symbol included in the transmission signals TSIG1 and TSIG2 may be generated based on at least one of a non-return to zero (NRZ), a pulse amplitude modulation-N (PAM-N), a bi-polar scheme, a Manchester scheme, and the like. In some implementations, the transmission signals TSIG1 and TSIG2 may be signals to which pre-distortion is applied.

An encoding scheme of at least one symbol included in the received signals RSIG1 and RSIG2 may be the same as an encoding scheme of the transmission signals TSIG1 and TSIG2 on which the received signals RSIG1 and RSIG2 are based. In some implementations, the transmission signals TSIG1 and TSIG2 may be random signals or may exhibit the same or similar characteristics as the random signals. Similarly, the received signals RSIG1 and RSIG2 generated based on the transmission signals TSIG1 and TISG2 may also be random signals or may exhibit the same or similar characteristics as the random signals.

The channels CH1 and CH2 may be channels of communication between the electronic devices 1100 and 1200. In some implementations, each of the channels CH1 and CH2 may be a wired communication channel. For example, the first channel CH1 and the second channel CH2 may be a wired communication channel and may be a communication channel between the first electronic device 1100 and the second electronic device 1200. For a more detailed example, the channels CH1, CH2 may be implemented as a waveguide, a transmission line, a strip line, a micro strip line, a combination thereof, or the like. In the following, the channels CH1, CH2 are described with reference to being wired communication channels, but it should be understood that the scope of the present disclosure is not limited thereto, and may also be applied to the case where the channels CH1, CH2 are wireless communication channels within the scope published in the present specification.

In some implementations, the first receiver RE1 may sample the first received signal RSIG1 to generate digital signals. The first receiver RE1 may include at least one feed forward equalizer. The feed forward equalizer may perform feed forward equalization on the sampled digital signals to remove inter-symbol interference (ISI) generated in the first received signal RSIG1 due to the response characteristic of the second channel CH2.

For example, the feed forward equalization may include operations of applying coefficients to respective digital signals and summing the signals in which the coefficients are applied (hereinafter referred to as FFE tap output signals). Each of the FFE tap output signals may include integer bits and fractional bits. Some bits of the fractional bits having a logic value “1” (e.g., a certain number of lower bits of the fractional bits) may not have a significant impact on the digital value of each of the FFE tap output signals. However, some of the bits described above may excessively increase the power consumption of the feed forward equalizer during the summing operation for the FFE tap output signals. Thus, when performing feed forward equalization by simply summing the FFE tap output signals, unnecessary power consumption of the feed forward equalizer may increase.

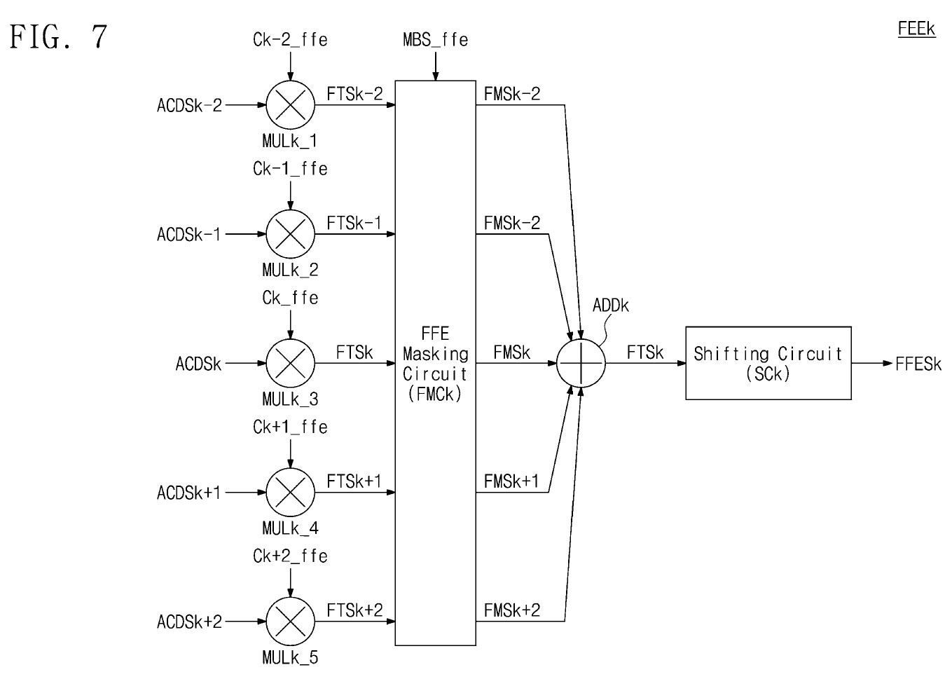

According to some implementations of the disclosure, the feed forward equalizer may perform a masking operation to adjust the digital value of each of the FFE tap output signals. As used throughout this specification, “adjust a digital value of a signal” may refer to adjusting a logic value of at least one of the bits of the signal. Due to the masking operation, the number of bits with a logic value “1” included in the FFE tap output signals can be reduced. The feed forward equalizer may perform feed forward equalization by summing signals whose digital value is adjusted (e.g., the FFE masking signals FMSk-2 to FMSk+2 in FIG. 7). The feed forward equalizer may perform the masking operation in a range in which the ISI mitigation performance satisfies the target performance. Accordingly, the ISI mitigation performance and power consumption of the feed forward equalizer can be optimized. The first receiver RE1 is described in more detail with reference to the following drawings.

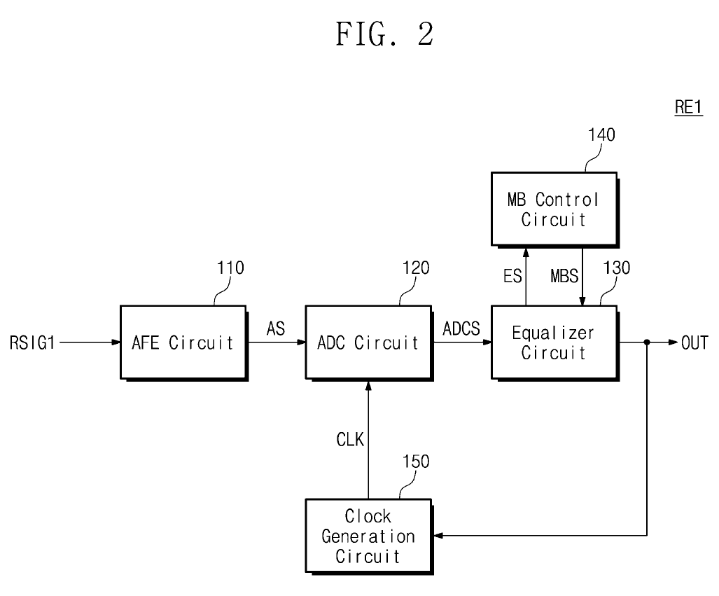

FIG. 2 is an example block diagram for describing the first receiver of FIG. 1. Although FIG. 2 is illustrated with reference to the first receiver RE1, the second receiver RE2 in FIG. 1 may be implemented in the same structure as the first receiver RE1. Referring to FIG. 2, the first receiver RE1 may include an analog front-end (AFE) circuit 110, an analog-to-digital conversion circuit 120, an equalizer circuit 130, a masking bit control circuit 140, and a clock generation circuit 150.

The analog front-end circuit 110 may receive the first received signal RSIG1 from the second channel CH2. In some implementations, the analog front-end circuit 110 may receive the first received signal RSIG1 generated by the second transmission signal TSIG2 transmitted from the second electronic device 1200 of FIG. 1 passing through the second channel CH2. In some implementations, the second transmission signal TSIG2 may include a plurality of symbols generated based on the PAM-4 scheme.

The analog front-end circuit 110 may perform an amplification operation (e.g., analog amplification) on the first received signal RSIG1 to output the amplified signal AS. For example, the analog front-end circuit 110 may perform analog amplification on a frequency band in which the symbols are included. The analog front-end circuit 110 may partially recover a signal that is lost due to the passage of a channel (e.g., the second channel CH2) based on the amplification operation.

In some implementations, the analog front-end circuit 110 may include a continuous time linear equalizer (CTLE) that performs high-pass filtering on the first received signal RSIG1, and a variable gain amplifier (VGA) that amplifies an output signal of the CTLE based on a variable gain.

The analog-to-digital conversion circuit 120 may generate digital values corresponding to the level of the amplification signal AS in synchronization with a clock signal CLK. That is, the analog-to-digital conversion circuit 120 may sample the level of the output signal AS to generate analog-to-digital conversion signals ADCS.

The equalizer circuit 130 may equalize the analog-to-digital conversion signals ADCS to remove the ISI of the analog-to-digital conversion signals ADCS. In some implementations, the equalizer circuit 130 may generate feed forward equalization signals by performing feed forward equalization (FFE) on the analog-to-digital conversion signals (ADCS). The equalizer circuit 130 may generate an output signal OUT by performing decision feedback equalization (DFE) on the feed forward equalization signals. The output signal OUT may include data corresponding to the symbols included in the first received signal RSIG1.

In some implementations, the equalizer circuit 130 may transmit the equalization signal ES to the masking bit control circuit 140. In some implementations, the equalizer circuit 130 may receive a masking bit control signal MBS from the masking bit control circuit 140. The equalizer circuit 130 may perform the masking operation based on the masking bit control signal MBS. In a process of performing feed forward equalization, the equalizer circuit 130 may generate FFE tap output signals by applying feed forward equalization coefficients in the analog-to-digital conversion signals ADCS. In some implementations, the equalizer circuit 130 may perform the masking operation based on the masking bit control signal MBS to change the digital values of the FFE tap output signals. The equalizer circuit 130 may generate feed forward equalization signals based on the changed digital values. In some implementations, the equalizer circuit 130 may transmit the equalization signal ES including the feed forward equalization signals to the masking bit control circuit 140.

The masking bit control circuit 140 may measure a SNR of the feed forward equalization signals based on the equalization signal ES. The masking bit control circuit 140 may generate the masking bit control signal MBS based on the measured SNR. The masking bit control signal MBS may include information on the number of FFE masking bits used in the masking operation. In some implementations, the masking bit control circuit 140 may determine the number of FFE masking bits for ISI mitigation performance and power consumption optimization of the feed forward equalization circuit 132.

The clock generation circuit 150 may generate the clock signal CLK required for operation of the analog-to-digital conversion circuit 120. In some implementations, the clock generation circuit 150 may generate or adjust the clock signal CLK based on the output signal OUT. For example, the clock generation circuit 150 may adjust the timing of the rising edge or the timing of the falling edge of the clock signal CS based on the output signal OUT.

In some implementations, the first receiver RE1 may include a digital signal processor. The digital signal processor may include the equalizer circuit 130 and the masking bit control circuit 140.

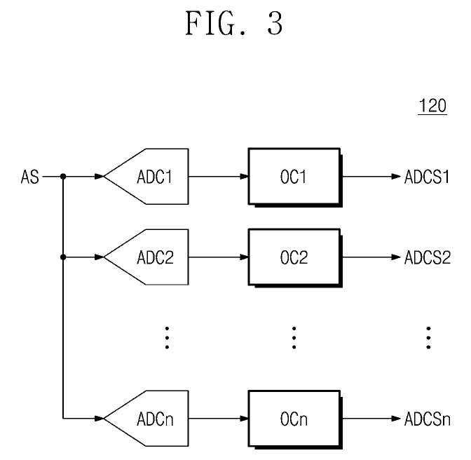

FIG. 3 is an example block diagram for describing the analog-to-digital conversion circuit of FIG. 2. Referring to FIGS. 2 and 3, the analog-to-digital conversion circuit 120 may include a plurality of analog to digital converters ADC1 to ADCn (where n is a natural number) and a plurality of offset compensators OC1 to OCn.

For example, the operating frequency of each of the plurality of analog-to-digital converters ADC1 to ADCn may be lower than the frequency of the first received signal RSIG1. For example, n may be 32, the frequency of the first received signal RSIG1 may be 32GHz, and the operating frequency of each of the plurality of analog-to-digital converters ADCµ to ADCn may be 1GHz. The plurality of analog-to-digital converters ADC1 to ADCn may convert the level of the input analog signal into digital values in a time interleaving manner.

For example, the first analog-to-digital converter ADC1 may convert the level of the input analog signal to a digital value at a first timing. At a second timing, the second analog-to-digital converter ADC2 may convert the level of the input analog signal to a digital value. At the n-th timing, the n-th analog-to-digital converter ADCn may convert the level of the input analog signal into a digital value. Then, again, the first analog-to-digital converter ADC1 may convert the level of the input analog signal into a digital value. In other words, the analog-to-digital conversion circuit 120 may operate as a deserializer.

For example, when n is 32, each of the plurality of analog-to-digital converters ADC1 to ADCn operating in the time interleaving manner may have an operating frequency of 1GHz and may form the analog-to-digital conversion circuit 120 having an operating frequency of 32GHz. In this case, for example, the clock signal CLK may include 32 clock signals at 1GHz, each having different phases. The plurality of analog-to-digital converters ADC1 to ADCn may operate in synchronization with 32 1GHz clock signals having different phases, respectively. That is, the plurality of analog-to-digital converters ADC1 to ADCn may operate at different timings in synchronization with the clock signal CLK. For example, each of the plurality of analog-to-digital converters ADC1 to ADCn may have a resolution of 5 bits to 8 bits.

The digital values generated by the plurality of analog-to-digital converters ADC1 to ADCn may be transferred to the plurality of offset compensators OC1 to OCn. The plurality of offset compensators OC1 to OCn may convert offsets of the plurality of analog-to-digital converters ADC1 to ADCn, respectively. The plurality of offset compensators OC1 to OCn may output a plurality of analog-to-digital converter signals ADCS1 to ADCSn (e.g., digital values) in which an offset is compensated. The analog-to-digital conversion signals ADCS1 to ADCSn may constitute the analog-to-digital conversion signal ADCS of FIG. 2.

For example, the number of analog-to-digital converters and the number of offset compensators ‘n’ may be determined as a multiple (e.g., 64, 128, etc.) of a value obtained by dividing a frequency of the first received signal RSIG1 by an operating frequency of each of the analog-to-digital converters.

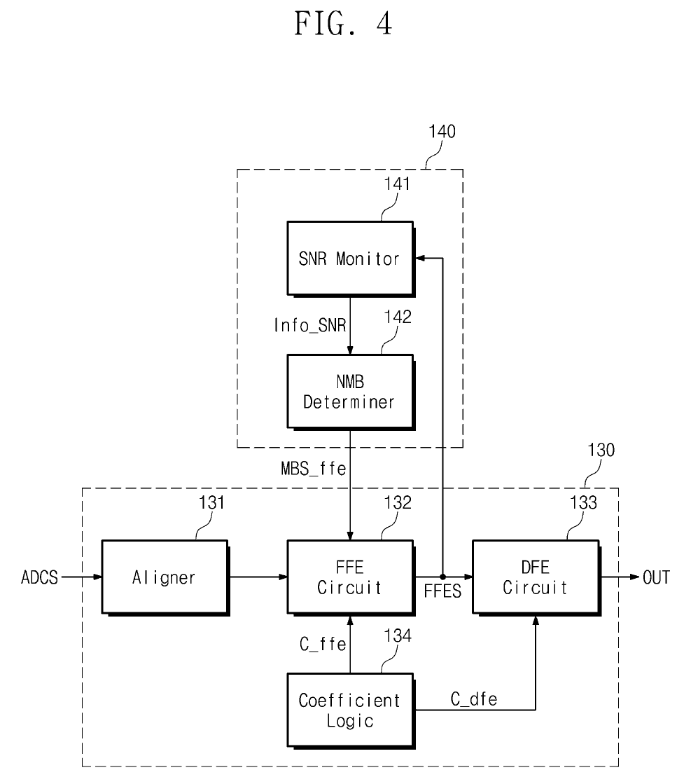

FIG. 4 is an example block diagram for describing the equalizer circuit and the masking bit control circuit of FIG. 2. Referring to FIGS. 2-4, the equalizer circuit 130 may include an aligner 131, a feed forward equalization circuit 132, a decision feedback equalization circuit 133, and a coefficient logic 134.

The aligner 131 may align the phases of the analog-to-digital conversion signals ADCS. For example, the analog-to-digital conversion signals ADCS1 to ADCSn of FIG. 3 may have different phases. The aligner 131 may align the phases of the analog-to-digital conversion signals ADCS1 to ADCSn in the same phase. Accordingly, the equalizer circuit 130 may operate at a board-rate based on digital signals aligned in the same phases.

The feed forward equalization circuit 132 may perform feed forward equalization on the digital signals output from the aligner 131 based on the feed forward equalization coefficients C_ffe output from the coefficient logic 134 and the FFE masking bit control signal MBS_ffe output form the masking bit number determiner 142. The feed forward equalization circuit 132 may output the feed forward equalization signals FFES as a result of the equalization. The masking bit control signal MBS of FIG. 2 may include the FFE masking bit control signal MBS_ffe.

The decision feedback equalization circuit 133 may perform decision feedback equalization on the feed forward equalization signals FFES based on the decision feedback equalization coefficients C_dfe output from the coefficient logic 134. The decision feedback equalization circuit 133 may output the equalization result to the output signal OUT.

The coefficient logic 134 may output the feed forward equalization coefficients C_ffe and the decision feedback equalization coefficients C_dfe. The coefficient logic 134 may adaptively adjust the feed forward equalization coefficients C_ffe and the decision feedback equalization coefficients C_dfe based on the output signal OUT.

The masking bit control circuit 140 may include an SNR monitor 141 and a masking bit number determiner 142. In some implementations, the SNR monitor 141 may monitor a signal-to-noise ratio (SNR) of the feed forward equalization signals FFES. The SNR monitor 141 may output SNR information info_SNR as a monitoring result The masking bit number determiner 142 may determine the number of FFE masking bit based on the SNR information info_SNR. The masking bit number determiner 142 may generate an FFE masking bit control signal MBS_ffe including information on the number of FFE masking bits.

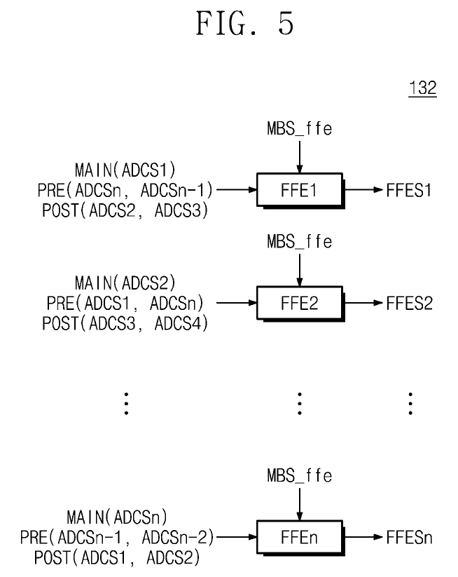

FIG. 5 is an example block diagram illustrating the feed forward equalization circuit of FIG. 4. Referring to FIGS. 4 and 5, the feed forward equalization circuit 132 may include a plurality of feed forward equalizers FFE1 to FEEn. Each of the plurality of feed forward equalizers FFE1 to FFEn may perform equalization based on a main signal MAIN, a pre-signal PRE, a post-signal POST, and a FFE masking bit control signal MBS_ffe among the plurality of analog-to-digital conversion signals ADCS1 to ADCS32. The plurality of feed forward equalizers FFE1 to FEEn may perform the equalization to generate feed forward equalization signals FFE1 to FFEn, respectively.

The main signal MAIN may be a target signal to be equalized by each of the plurality of feed forward equalizers FFE1 to FEEn. The pre-signal PRE may be signals received before the main signal MAIN. The post signal POST may be signals received after the main signal MAIN.

For example, the first feed forward equalizer FFE1 may generate a first FFE tap output signals by multiplying the first analog-to-digital conversion signal ADCS1, which is the main signal MAIN, by a corresponding coefficient among the feed forward equalization coefficients C_ffe, multiplying the (n–1)th and nth analog-to-digital conversion signals ADCSn-1 and ADCSn, which are the pre-signal PRE, by their respective corresponding coefficients among the feed forward equalization coefficients C_ffe, and multiplying the second and third analog-to-digital conversion signals ADCS2 and ADCS3, which are the post signal POST, by their respective corresponding coefficients among the feed forward equalization coefficients C_ffe. The first feed forward equalizer FFE1 may perform a masking operation based on the FFE masking bit control signal MBS_ffe to adjust a digital value of each of the first FFE tap output signals. The first feed forward equalizer FFE1 may sum the adjusted signals to generate the first feed forward equalization signal FFES1.

For example, the first analog-to-digital conversion signal ADCS1 which is the main signal MAIN, the second analog-to-digital conversion Signal ADCS2 and the third analog-to-digital conversion Signal ADCS3, which are the post signal POST, may be signals generated by the analog-to-digital conversion circuit 120 during a first operation period. The (n−1)th analog-to-digital conversion signal ADCSn−1 and the nth analog- to-digital conversion signals ADCSn, which are the pre-signal PRE, may be signals generated by the analog-to-digital conversion circuit 120 during a 0th operation period before the first operation period.

For example, the nth feed forward equalizer FFEn may generate nth FFE tap output signals by multiplying the nth analog-to-digital conversion signal ADCSn, which is the main signal MAIN, by a corresponding coefficient among the feed forward equalization coefficients C_ffe, multiplying the (n–1)th and (n–2)th analog-to-digital conversion signals ADCSn–1 and ADCSn–2, which are the pre-signal PRE, by their respective corresponding coefficients among the feed forward equalization coefficients C_ffe, and multiplying the first and second analog-to-digital conversion signals ADCS1 and ADCS2, which are the post signal POST, by their respective corresponding coefficients among the feed forward equalization coefficients C_ffe. The nth feed forward equalizer FFEn may perform the masking operation based on the FFE masking bit control signal MBS_ffe to adjust a digital value of each of the n-th FFE tap output signals. The nth feed forward equalizer FFEn may sum the adjusted signals to generate the nth feed forward equalization signal FFESn.

For example, the nth analog-to-digital conversion signal ADCSn which is the main signal MAIN, the (n-1)th analog-to-digital conversion signals ADCSn-1 and the (n-2)th analog- to-digital conversion signals ADCSn-2 which are the pre-signal PRE may be signals generated by the analog-to-digital conversion circuit 120 during a first operation period. The first analog-to-digital conversion signal ADCS1 and the second analog-to-Digital Conversion signal ADCS2, which are the post signal POST, may be signals generated by the analog-to-digital conversion circuit 120 during a second operation period after the first operation period.

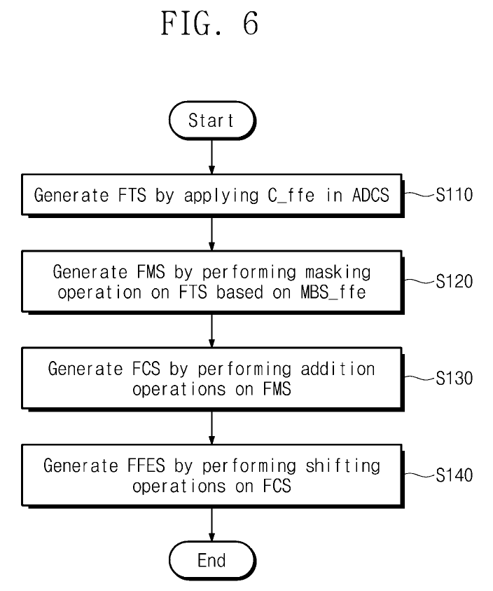

FIG. 6 is a flowchart for describing an example of an operation method of the feed forward equalization circuit of FIG. 5. Referring to FIGS. 5 and 6, in step S110, the feed forward equalization circuit 132 may generate the FFE tap output signals FTS by applying the feed forward equalization coefficients C_ffe to the analog-to-digital conversion signals ADCS, respectively.

In step S120, the feed forward equalization circuit 132 may perform a masking operation on the FFE tap output signals FTS based on the FFE masking bit control signal MBS_ffe to generate FFE masking signals FMS. In some implementations, the masking operation may be an operation of adjusting a digital value of the FFE tap output signals FTS. Specifically, the masking operation may be an operation of adjusting a logic value of at least some of the least significant bits corresponding to the number of FFE masking bits among the bits of the FFE tap output signals FTS. The FFE masking bit control signal MBS_ffe may include information about the number of FFE masking bits.

In step S130, the feed forward equalization circuit 132 may perform addition operations on the FFE masking signals FMS to generate the FFE computation signals FCS. For example, each of the feed forward equalizers FFE1 to FFEn may perform an addition operation on the generated FFE masking signals FMS to generate the FFE computation signals FCS.

In step S140, the feed forward equalization circuit 132 may perform a shifting operation on each of the FFE computation signals FCS to generate the feed forward equalization signals FFES. In some implementations, the shifting operation may be an operation of excluding some bits of bits of each of the FFE computation signals FCS.

FIG. 7 is an example diagram for describing the feed forward equalizer of FIG. 5. FIG. 7 illustrates a kth feed forward equalizer FFEk (k is a natural number smaller than n) among the feed forward equalizers FFE1 to FFEn of FIG. 5. The feed forward equalizers FFE1-FFEn of FIG. 5 may be implemented in the same structure as the kth feed forward equalizer FFEk of FIG. 7. Referring to FIG. 7, the kth feed forward equalizer FFEk may generate a kth feed forward equalization signal FFESk based on the analog-to-digital conversion signals ADCSk-2 to ADCSk+2. The kth feed forward equalizer FFEk may include a plurality of multipliers MULk_1 to MULk_5, an FFE masking circuit FMCk, an adder ADDk, and a shifting circuit SCk.

The plurality of multipliers MULk_1 to MULk_5 may respectively apply the feed forward equalization coefficients Ck-2_ffe to Ck+2_ffe in the analog-to-digital conversion signals ADCSk-2 to ADCSk+2. Specifically, the first multiplier MULk_1 may output the (k−2)th FFE tap output signal FTSk−2 by multiplying the (k−2)th analog-to-digital conversion signal ADCSk−2 by the (k−2)th feed forward equalization coefficient Ck−2_ffe. The second multiplier MULk_2 may output the (k−1)th FFE tap output signal FTSk−1 by multiplying the (k−1)th analog-to-digital conversion signal ADCSk−1 by the (k−1)th feed forward equalization coefficient Ck−1_ffe. The third multiplier MULk_3 may output the kth FFE tap output signal FTSk by multiplying the kth analog-to-digital conversion signal ADCSk by the kth feed forward equalization coefficient Ck_ffe. The fourth multiplier MULk_4 may output the (k+1)th FFE tap output signal FTSk+1 by multiplying the (k+1)th analog-to-digital conversion signal ADCSk+1 by the k+1th feed forward equalization coefficient Ck+1_ffe. The fifth multiplier MULk_5 may output the (k+2)th FFE tap output signal FTSk+2 by multiplying the (k+2)th analog-to-digital conversion signal ADCSk+2 by the (k+2)th feed forward equalization coefficient Ck+2_ffe.

The FFE masking circuit FMCk may perform the masking operation on the FFE tap output signals FTSk-2 to FTSk+2 based on the FFE masking bit control signal MBS_ffe received from the masking bit number determiner 142. The FFE masking circuit FMCk may perform a masking operation to adjust digital values of the FFE tap output signals FTSk-2 to FTSk+2. The FFE masking circuit FMCk may output signals whose digital values are adjusted to the FFE masking signals FMSk-2 to FMSk+2. In some implementations, the FFE masking bit control signal MBS_ffe may include information about the number of FFE masking bits. For example, the number of FFE masking bits may be m (m is a natural number). In this case, in some implementations, the masking operation may be an operation of adjusting a logic value of the lowest m bits corresponding to the number of FFE masking bits among the bits of the FFE tap output signal to “0”. The FFE masking circuit FMCk may generate the FFE masking signals FMSk-2 to FMSk+2 by performing a masking operation on each of the FFE tap output signals FTSk-2 to FTSk+2.

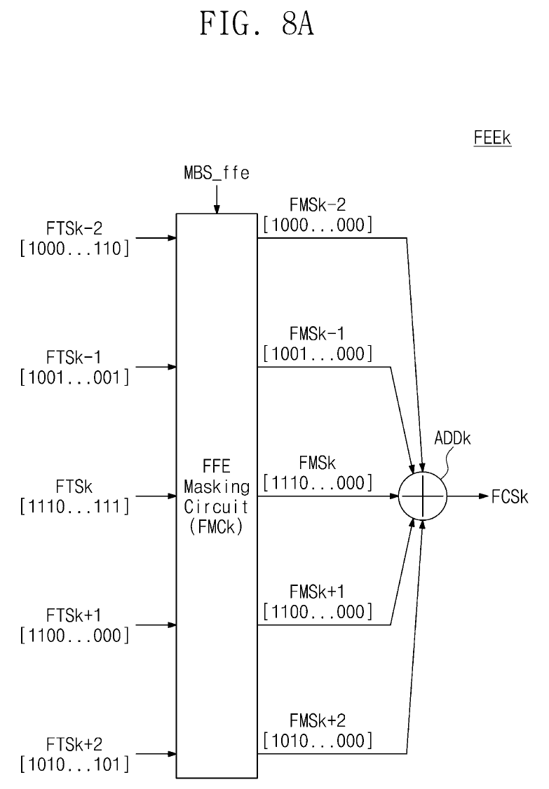

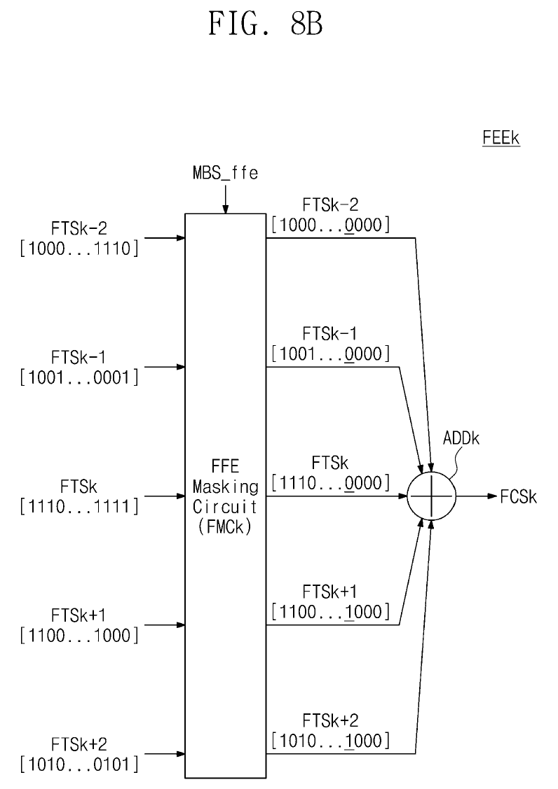

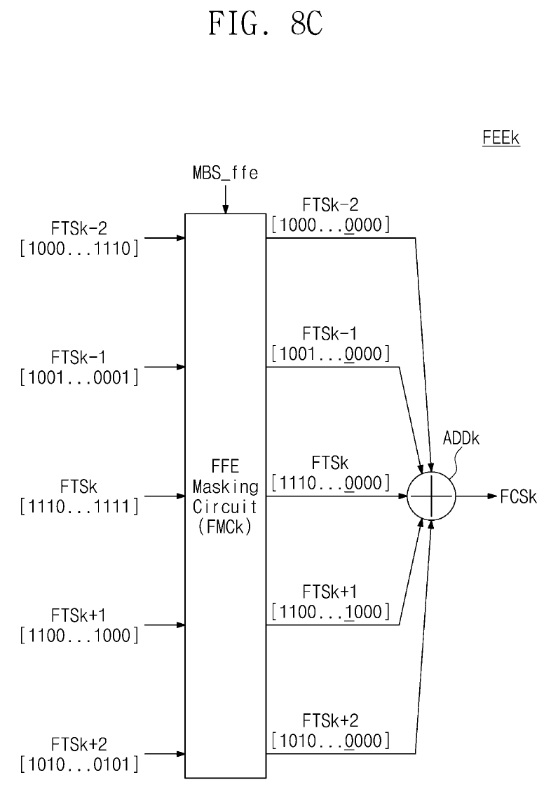

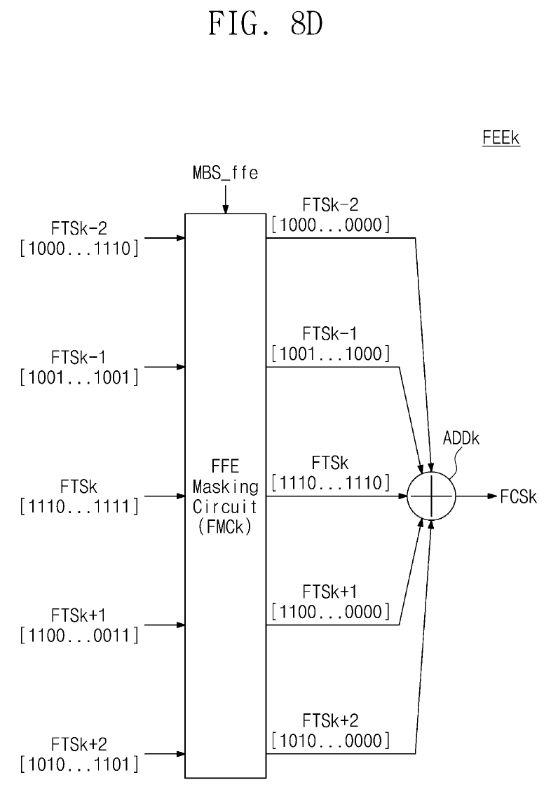

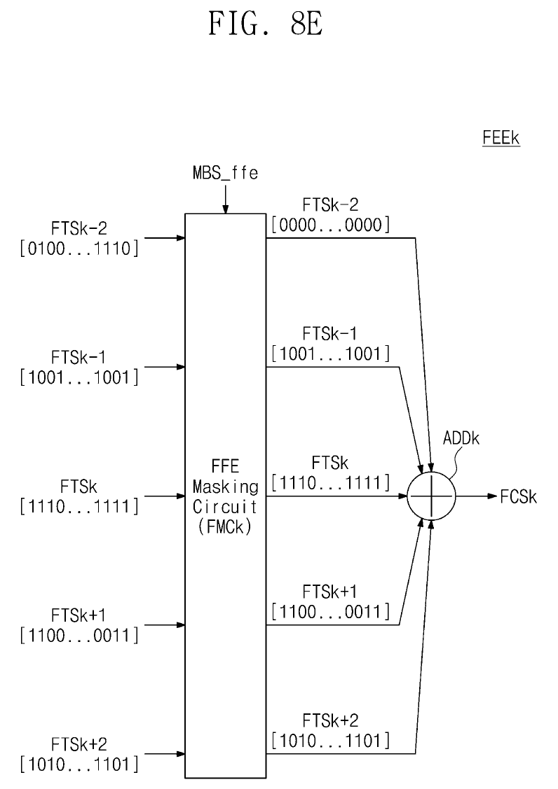

Specifically, for example, the FFE masking circuit FMCk may generate the (k−2)th FFE masking signal FMSk−2 by adjusting the logic value of the lowest m bits among the bits of the (k−2)th FFE tap output signal FTSk−2 to “0”, may generate the (k−1)th FFE masking signal FMSk−1 by adjusting the logic values of the lowest m bits among the bits of the (k−1)th FFE tap output signal FTSk−1 to “0”, may generate the kth FFE Masking signal FMSk by adjusting the logic values of the lowest m bits among the bits of the kth FFE tap output signal FMSk to “0” and may generate the (k+1)th FFE Masking signal FMSk+1 by adjusting the logic values of the lowest n bits among the bits of the (k+1)th FFE tap out signal FTSk+1 to “0”. The masking operation is described in more detail with reference to FIGS. 8A-8E.

The adder ADDk may perform an addition operation on the FFE masking signals FMSk-2 to FMSk+2. For example, the adder ADDk may perform a bitwise addition operation on the FFE masking signals FMSk-2 to FMSk+2. The adder ADDk may generate the kth FFE computation signal FCSk by summing the FFE masking signals FMSk-2 to FMSk+2.

The logic value “1” of a particular bit may correspond to a high level of voltage. Accordingly, the power consumption of the adder ADDk may increase as the number of bits having the logic value “1” input to the adder ADDk increases (e.g., because the computational complexity in the adder ADDk increases).

For example, the FFE masking number may be greater than “0”. In this case, the number of bits having the logic value “1” included in the FFE masking signals FMSk-2 to FMSk+2 may be smaller than the number of bits having the logic value "1" included in the FFF tap output signals FTSk-2 to FTSk+2. Accordingly, power consumption of the adder ADDk may be reduced compared to a case where the kth FFE computation signal FCSk is generated by summing the FFE tap output signals FTSk-2 to FTSk+2.

The shifting circuit SCk may perform a shifting operation on the kth FFE operation signal FCSk. The shifting operation may be an operation of excluding some bits from the bits of the kth FFE operation signal FCSk. The shifting circuit SCk may output a signal excluding some bits of the bits of the kth FFE operation signal FCSk as the kth feed forward equalization signal FFESk. In some implementations, the kth FFE computation signal FCSk may include integer bits and fractional bits. In some implementations, the shifting operation may be an operation of excluding the fractional bits from bits of the kth FFE operation signal FCSk. In this case, the shifting circuit SCk may output the integer bits of the kth FFE computation signal FCSk as the kth feed forward equalization signal FFESk.

Unlike described above, for example, the feed forward equalizers FFE1 to FFEn may not include the FFE masking circuit FMCk. In this case, the feed forward equalizer (e.g., FFEk) may sum the FFE tap output signals (e.g., FTSk−2 to FTSk+2) to generate an FFE computation signal (e.g., FCSk) and generate kth feed forward equalization signal (FFESk) based on FFE computation signal (e.g., FCSk). At this time, the SNR of the feed forward equalization signals FFES1 to FFESn may be greater than a target SNR. However, compared to the case where the masking operation is performed, the computational complexity in the adder ADDk may increase. Therefore, power consumption of the adder ADDk may increase. That is, the ISI mitigation performance of the FFE circuit 132 may be higher than the target performance, but the power consumption of the FFE Circuit 132 may be excessively large.

According to some implementations of the present disclosure, each of the feed forward equalizers FFE1 to FFEn may include a FFE masking circuit (e.g., FMCk). The FFE masking circuit (e.g., FMCk) may perform a masking operation on the FFE tap output signals (e.g., FTSk−2 to FTSk+2) in a range in which the SNRs of the feed forward equalization signals FFES1 to FFESn satisfy a target SNR level. Accordingly, the computational complexity in the adder ADDk may be reduced. Therefore, power consumption of the adder ADDk may be reduced. In addition, the ISI mitigation performance of the feed forward equalization circuit 132 may satisfy a target performance level. In other words, as each of the feed forward equalizers FFE1 to FFEn adjusts the digital value of the FFE tap output signals (e.g., FTSk-2 to FTSk+2), the ISI mitigation performance and power consumption of the feed forward equalization circuit 132 may be optimized.

FIG. 7 illustrates the kth feed forward equalizer FFEk having a 5-tap structure, but the present disclosure is not limited thereto, and the number of taps of each of the feed forward equalizers FFE1 to FFEn may be variously changed.

Unlike described above with reference to FIG. 7, in some implementations, the masking operation may be performed on the analog-to-digital conversion signals ADCk-2 to ADCk+2. In this case, the FFE masking circuit FMCk may be located between the analog-to-digital conversion circuit 120 and the plurality of multipliers MULk_1 to MULk_5. FFE masking circuit FMCk may adjust a digital value of each of the analog-to-digital conversion signals ADCk-2 to ADCk+2 based on the masking bit control signal MBS_ffe. The adjusted analog-to-digital conversion signals may be input to the plurality of multipliers MULk_1 to MULk_5. Accordingly, power consumption in the plurality of multipliers MULk_1 to MULk_5 may be reduced.

In some implementations, the masking operation may be performed on the FFE coefficients Ck−2_ffe to Ck+2_ffe. In this case, the FFE masking circuit FMCk may be located between the coefficient logic 134 and the plurality of multipliers MULk_1 to MULk_5. FFE masking circuit FMCk may adjust a digital value of each of the FFE coefficients Ck−2_ffe to Ck+2_ffe based on the masking bit control signal MBS_ffe. The adjusted FFE coefficients Ck−2_ffe to Ck+2_ffe may be input to a plurality of multipliers MULk_1 to MULk_5. Accordingly, power consumption in the plurality of multipliers MULk_1 to MULk_5 may be reduced.

FIGS. 8A, 8B, 8C, 8D, and 8E are diagrams for describing an example of a masking operation of the FFE masking circuit of FIG. 7. For convenience of description, components unnecessary to describe the masking operation of the FFE masking circuit FMCk are omitted. Referring to FIGS. 7 and 8A, the FFE masking circuit FMCk may receive the FFE tap output signals FTSk-2 to FTSk+2 from the plurality of multipliers MULk_1 to MULk_5 and receive the FFE masking bit control signal MBS_ffe from the masking bit number determiner 142.

For example, each of the analog-to-digital conversion signals ADCSk-2 to ADCSk+2 may be 8 bits, and each of the feed forward equalization coefficients Ck-2 to Ck+2 may be 10 bits. Accordingly, each of the FFE tap output signals FTSk-2 to FTSk+2 may be a 17-bit digital signal. For example, the upper 9 bits of each of the FFE tap output signals FTSk-2 to FTSk+2 may constitute an integer portion, and the lower 8 bits may constitute a fractional portion. However, the present disclosure is not limited thereto, and the number of bits of the analog-to-digital conversion signals ADCSk-2 to ADCSk+2 and the feed forward equalization coefficients Ck-2 to Ck+2 may be variously changed. In addition, among the bits of each of the FFE tap output signals FTSk-2 to FTSk+2, the number of bits configuring the integer portion and the number of bits configuring the fractional portion may also be variously changed.

In some implementations, the masking operation may be an operation of determining, in each of the FFE tap output signals FTSk-2 to FTSk+2, lowest bits corresponding to the number of FFE masking bits as masking data and adjusting a logic value of bits having a logic value “1” among bits of the masking data to “0”.

As shown in FIG. 8A, for example, the (k−2)th FFE tap output signal FTSk−2 may be “1000...110”, the (k−1)th FFE tap output signal FTSk−1 may be “1001... 001”, the kth FFE tap output signal FTSk may be “1110...111”, the (k+1)th FFE tap output signal FTSk+1 may be “1100...000”, and the (k+2)th FFE tap output signal FTSk+2 may be “1010…101”. In addition, the FFE masking bit control signal MBS_ffe may indicate that the current number of FFE masking bits is three.

In this case, the FFE masking circuit FMCk may determine the lowest three bits of each of the FFE tap output signals FTSk-2 to FTSk+2 as masking data and adjust a logic value of the bits of the masking data to output the FFE masking signals FMSk-2 to FMSk+2. At this time, the (k−2)th FFE masking signal FMSk−2 may be “1000...000”, the (k−1)th FFE masking signal FMSk−1 may be “1001...000”, the kth FFE Masking signal FMSk may be “1110...000”, the (k+1)th FFE masking signal FMSk+1 may be “1100...000”, and the (k+2)th FFE masking signal FMS(k+2) may be “1010…000”.

The adder ADDk may generate the kth FFE computation signal FCSk by summing the FFE masking signals FMSk-2 to FMSk+2. In the example of FIG. 8A, as the masking operation is performed, the number of bits having the logic value “1” input to the adder ADDk may be reduced by eight compared to the case of performing the addition operation on the tap output signals FTSk-2 to FTSk+2. Accordingly, the computational complexity of the adder ADDk may be reduced. Therefore, power consumption of the adder ADDk may be reduced.

A lower bit of the bits of the FFE tap output signal (e.g., FTSk) may have a smaller impact on the magnitude of the digital value of the FFE tab output signal (e.g., FTSk). According to some implementations of the present disclosure, the FFE masking circuit FMCk may reduce the power consumption of the adder ADDk without significantly reducing the ISI mitigation performance of the kth feed forward equalizer FFEk by adjusting the bit value of the lower bits of each of the FFE tap output signals FTSk-2 to FTSk+2 through a masking operation.

Referring to FIG. 8B, in some implementations, the masking operation may include determining, in each of the FFE tap output signals FTSk-2 to FTSk+2, lowest bits corresponding to the number of FFE masking bits as masking data, and when a logic value of a most significant bit of the masking data is “1”, performing a round up operation on the most significant bit, and adjusting a logic value of remaining bits of the masking d to “0”. In addition, the masking operation may include adjusting the logic value of all bits of the masking data to “0” when the logic value of the most significant bit of the masking data is “0”.

As shown in FIG. 8B, for example, the (k−2)th FFE tap output signal FTSk−2 may be “1000...1110”, the (k−1)th FFE tap output signal FTSk−1 may be “1001...0001”, the kth FFE tap output signal FTSk may be “1110...1111”, the (k+1)th FFE tap output signal FTSk+1 may be “1100…1000”, and the (k+2)th FFE tap output signal FTSk+2 may be “1010…0101”. In addition, the FFE masking bit control signal MBS_ffe may indicate that the current number of FFE masking bits is three.

In this case, the FFE masking circuit FMCk may determine the lowest three bits of each of the FFE tap output signals FTSk-2 to FTSk+2 as masking data, and when the logic value of the most significant bit among the bits of the masking data is “1”, perform a round up operation on the most significant bit, and adjust the logic value of remaining bits to “0” to generate the FFE masking signals FMSk-2 to FMSk+2.

Specifically, the FMC masking circuit FMC may determine the lowest three bits in the (k−2)th FFE tap output signal FTSk−2 as masking data “110”. Since the logic value of the most significant bit of the masking data “110” is “1”, the FFE masking circuit FMCk may perform a round up operation on the most significant bit and adjust the logic value of a bit whose logic value is “1” among the remaining bits “10” to “0”. Accordingly, the (k−2)th FFE masking signal FMSk−2 may be “1000... 0000”.

In addition, the FFE masking circuit FMCk may determine the lowest three bits in the (k−1)th FFE tap output signal FTSk−1 as the masking data “001”. Since the logic value of the most significant bit of the masking data “001” is “0”, the FMC masking circuit FMC may adjust the masking data such that the logic value of all bits of the masking Data “001” becomes “0”. Accordingly, the (k−1)th FFE masking signal FMSk−1 may be “1001...0000”.

The FFE masking circuit FMCk may perform the above-described masking operation on the FFE tap output signals FTSk to FSTk+2. Accordingly, the kth FFE masking signal FMSk may be “1110...0000”, the (k+1)th FFE masking signal FMSk+1 may be “1100…1000”, and the (k+1)th FFE masking signal FMSk+2 may be “1010…1000”.

Due to the round up operation, the number of bits having the logic value “1” of the kth FFE masking signal FMSk and the (k-2)th FFE masking signal FMSk-2 may decrease compared to the case of simply adjusting the logic value of the lower bits of the number of FFE masking bits to “0”. Accordingly, power consumption in the adder ADDk may be reduced.

Referring to FIG. 8C, in some implementations, the masking operation may include determining, in the FFE tap output signals FTSk-2 to FTSk+2, lowest bits corresponding to the number of FFE masking bits as masking data. In addition, the masking operation may include, when a logic value of a most significant bit of bits of the masking data is “1” and a logic value of an upper bit of the most significant bit of the masking data in the FFE tap output signal is “1”, performing a round up operation on the most significant bits of the masking data, and adjusting the logic values of the remaining bits of the masking data to “0”. In addition, the masking operation may include adjusting a logic value of all bits of the masking data to “0” when a logic value of an upper bit of a most significant bit of the masking data in the FFE tap output signal is “0”.

As shown in FIG. 8C, for example, the (k−2)th FFE tap output signal FTSk−2 may be “1000...1110”, the (k−1)th FFE tap output signal FTSk−1 may be “1001...0001”, the kth FFE tap output signal FTSk may be “1110...1111”, the (k+1)th FFE tap output signal FTSk+1 may be “1100…1000”, and the (k+2)th FFE tap output signal FTSk+2 may be “1010…0101”. In addition, the FFE masking bit control signal MBS_ffe may indicate that the current number of FFE masking bits is three.

In this case, the FFE masking circuit FMCk may determine the lowest three bits in the (k−2)th FFE tap output signal FTSk−2 as masking data “110”. Since the logic value of the most significant bit of the masking data “110” is “1” and the logic value of an upper bit of the most significant bit of the masking data “110” in the (k−2)th tap output signal FTSk−2 is “1”, the FFE masking circuit FMCk may perform a round up operation on the most significant bit and adjust the logic value of a bit whose logic value is “1” among the remaining bits “10” to “0”. Accordingly, the (k−2)th FFE masking signal FMSk−2 may be “1000...0000”.

In addition, the FFE masking circuit FMCk may determine the lowest three bits in the (k+2)th FFE tap output signal FTSk+2 as the masking data “101”. Since the logic value of the most significant bit of the masking data “101” is “1”, and the logic value of an upper bit of the most significant bit of the masking data “101” in the (k+2)th tap output signal FTSk+2 is “0”, the FFE masking circuit FMCk may adjust the logic value of all bits of the masking data “101” to “0” without performing the round up operation on the most significant bit. Accordingly, the (k+2)th FFE masking signal FMSk+2 may be “1010...0000”.

According to the example of FIG. 8C, the FFE masking circuit FMCk may perform the round up operation on the most significant bit of the masking data only when the logic value of the most significant bit among the bits of the masking data is “1”, and the logic value of an upper bit of the most significant bit of the masking data in the FFE tap output signal is “1”. Accordingly, the FFE masking circuit FMCk may prevent an increase in the number of bits having the logic value “1” in the FEE masking signal due to the round up operation, such as the (k+2)th FFE masking signal FMSk+2 in FIG. 8B.

Referring to FIG. 8D, in some implementations, the number of FFE masking bits corresponding to each of the FFE tap output signals FTSk-2 to FTSk+2 may be different from each other.

As shown in FIG. 8D, for example, the (k−2)th FFE tap output signal FTSk−2 may be “1000...1110”, the (k−1)th FFE tap output signal FTSk−1 may be “1001...1001”, the kth FFE tap output signal FTSk may be “1110...1111”, the (k+1)th FFE tap output signal FTSk+1 may be “1100…0011”, and the (k+2)th FFE tap output signal FTSk+2 may be “1010…0000”.

In addition, the FFE masking bit control signal MBS_ffe may indicate that the number of FFE masking bits corresponding to the (k−2)th FFE tap output signal FTSk−2 and the (k+2)th FFE tap output signal FDSk+2 is four, the number of FFE masking bits corresponds to the (k−1)th FFE tab output signal FTSk−1 and the (k+1)th FFE tap output signal FTSk+1 is two, and the number of FFE masking bits correspond to the kth FFE tap output signal FTSk is one. In this case, the number of bits whose logic value is changed by the masking operation may vary for each of the FFE tap output signals FTSk-2 to FTSk+2.

For example, when the masking operation is the operation described with respect to FIG. 8A, the FFE masking circuit FMCk may perform the masking operation to adjust the logic value of the lowest four bits of each of the (k−2)th tap output signal FTSk−2 and the (k+2)th FFE tap output signals FTSk+2. Accordingly, the (k−2)th FFE masking signal FMSk−2 may be “1000...0000”, and the (k+2)th FFE masking signal FMSk+2 may be “1010...0000”. In addition, the FFE masking circuit FMCk may perform a masking operation to adjust logic values of the lowest two bits of each of the (k−1)th tap output signal FTSk−1 and the (k+1)th FFE tap output signals FTSk+1. Accordingly, the (k−1)th FFE masking signal FMSk−1 may be “1001...1000”, and the (k+1)th FFE masking signal FMSk+1 may be “1100...0000”. In addition, the FFE masking circuit FMCk may perform a masking operation to adjust the logic value of the least significant bit of the kth tap output signal FTSk. Accordingly, the kth FFE masking signal FMSk may be “1110...1110”.

As described above, the FFE masking circuit FMCk may perform the masking operation by varying the number of FFE masking bits corresponding to the main signal MAIN and the number of FFE masking bits corresponds to the pre-signal PRE and the post-signal POST. In some implementations, the number of the FFE masking bits corresponding to the main signal MAIN may be smaller than the number of FFE masking bits corresponding to the pre-signal PRE and the post-signal POST.

Referring to FIG. 8E, in some implementations, the FFE masking circuit FMCk may perform a masking operation on the entirety of a specific tap output signal. In this case, the FFE masking bit control signal MBS_ffe may include information about a tap output signal that is a target of performing the masking operation.

For example, the FFE masking bit control signal MBS_ffe may indicate that the (k−2)th tap output signal FTSk−2 is the target to perform the masking operation. In this case, the FFE masking circuit FMCk may perform the masking operation to adjust a logic value of all bits of the (k−2)th tap output signal FTSk−2 to “0”.

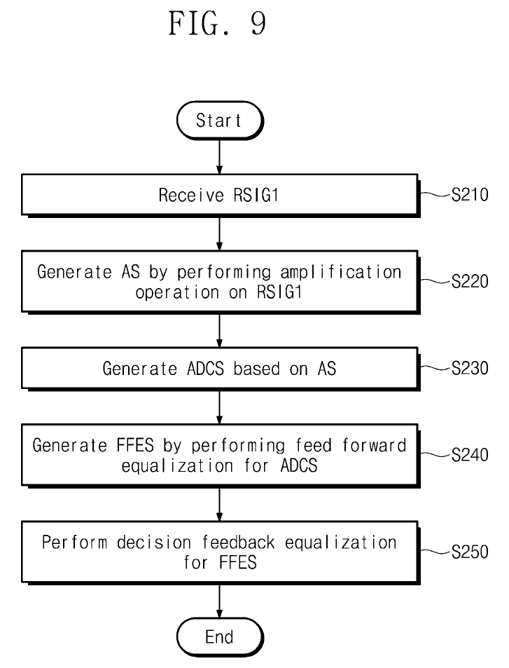

FIG. 9 is a flowchart for describing an example of an operation method of the first receiver of FIG. 2. Referring to FIGS. 2, 4, and 9 in step S210, the first receiver RE1 may receive the first received signal RSIG1.

In step S220, the first receiver RE1 may perform an amplification operation on the first received signal RSIG1 to generate the amplified signal AS. For example, the analog front-end circuit 110 may perform an amplification operation (e.g., analog amplification) on the first received signal RSIG1 to generate the amplified signal AS.

In step S230, the first receiver RE1 may generate the analog-to-digital conversion signals ADCS based on the amplified signal AS. For example, the analog-to-digital conversion circuit 120 may perform digital sampling on the amplified signal AS to generate analog-to-digital conversion signals ADCS.

In step S240, the first receiver RE1 may perform feed forward equalization on the analog-to-digital conversion signals ADCS to generate the feed forward equalization signals FFES. For example, the equalizer circuit 130 may perform feed forward equalization on the analog-to-digital-conversion signals ADCS based on the FFE masking bit control signal MBS_ffe to generate the feed forward equalization signals FFES.

In step S250, the first receiver RE1 may perform decision feedback equalization on the feed forward equalization signals FFES. For example, the equalizer circuit 130 may generate the output signal OUT by performing decision feedback equalization on the feed forward equalization signals FFES.

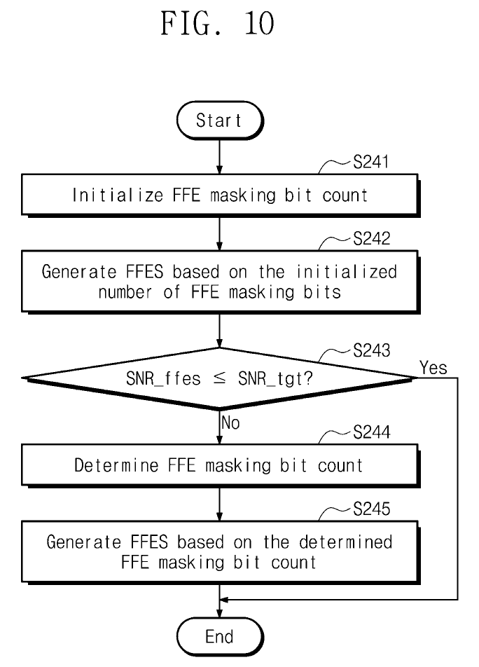

FIG. 10 is an example flowchart for describing step S240 of FIG. 9. Referring to FIG. 10, in step S241, the first receiver RE1 may initialize the number of masking bits. For example, the masking bit number determiner 142 may initialize the number of FFE masking bits by setting the current number of FFE Masking bits to “0”. The masking bit number determiner 142 may output an FFE masking bit control signal MBS_ffe including information indicating that the current number of FFE masking bits is “0”.

In step S242, the first receiver RE1 may generate the feed forward equalization signals FFES based on the initialized number of FFE masking bits (e.g., “0”). For example, the feed forward equalization circuit 132 may generate feed forward equalization signals FFES based on the current number of masking bits (“0”). In this case, the feed forward equalization signals FFES may correspond to feed forward equivalent signals FFES generated without performing a masking operation on the FFE tap output signals (e.g., FTSk−2 to FTSk+2). That is, the FFE masking circuit FMCk may generate the feed forward equalization signals FFES without performing a masking operation.

In step S243, the first receiver RE1 may compare the current SNR SNR_ffes of the feed forward equalization signals FFES with the target SNR SNR_tgt. For example, the SNR monitor 141 may measure the current SNR SNR_ffes of the feed forward equalization signals FFES. The masking bit number determiner 142 may compare the current SNR SNR_ffes with the target SNR SNR_tgt. When the current SNR SNR_ffes is less than or equal to the target SNR SNR_tgt, the masking bit number determiner 142 may determine the final number of FFE masking bits as “0”. In addition, the current feed forward equalization signals FFES may be input to the decision feedback equalization circuit 133. When the current SNR SNR_ffes is greater than the target SNR SNR_tgt, the first receiver RE1 may perform step S244. On the other hand, when the current SNR SNR_ffes of the feed forward equalization signals FFES is smaller than the target SNR SNR_tgt, the first receiver RE1 may not satisfy the target performance.

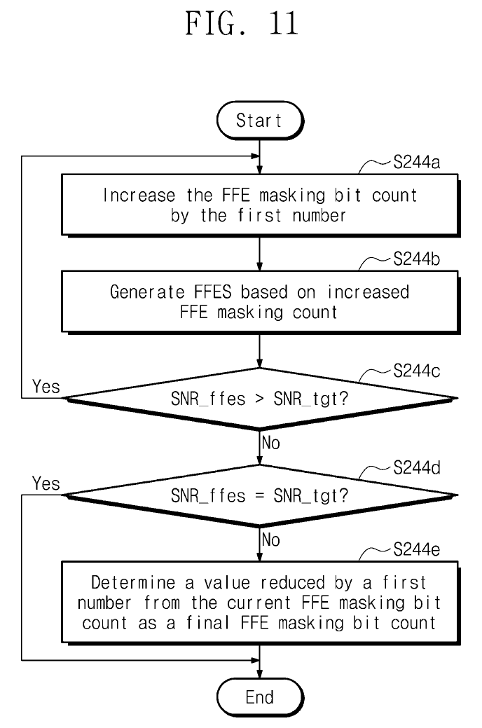

In step S244, the first receiver RE1 may determine the number of FFE masking bits. For example, the masking bit number determiner 142 may determine the FFE masking bit number for optimizing ISI mitigation performance and power consumption. The masking bit number determiner 142 may output the FFE masking bit control signal MBS_ffe including information on the determined number of FFE masking bits. Step S244 is described in more detail with reference to FIG. 11.

In step S245, the first receiver RE1 may generate the feed forward equalization signals FFES based on the determined number of FFE masking bits. For example, the feed forward equalization circuit 132 may generate feed forward equalization signals FFES by the method described with reference to FIG. 6. Specifically, the feed forward equalization coefficients C_ffe may be respectively reflected in the analog-to-digital conversion signals ADCS of the feed forward equalization circuit 132 to generate tap output signals. The feed forward equalization circuit 132 may change the digital value of each of the tap output signals to generate FFE masking signals through the masking operation based on the determined number of FFE masking bits. The feed forward equalization circuit 132 may perform addition operations on the FFE masking signals to generate FFE computation signals. The feed forward equalization circuit 132 may generate the feed forward equalization signals FFES by performing the shifting operation on the FFE operation signals. The feed forward equalization circuit 132 may transmit the feed forward equalization signals FFES generated based on the determined number of FFE masking bits to the decision feedback equalization circuit 133.

According to some implementations of the present disclosure, the computational complexity of the addition operation in the feed forward equalization circuit 132 may be reduced through the masking operation. The computational complexity may decrease in the range in which the ISI mitigation performance of the forward equalization circuit 132 satisfies the target performance. Accordingly, ISI mitigation performance and power consumption of the feed forward equalization circuit 132 may be optimized.

Meanwhile, in some implementations, when communication with an external device (for example, the second electronic device 1200 of FIG. 1) is started, the first receiver RE1 may perform steps S241 to S244 described above. For example, steps S241 to S244 described above may be performed based on the analog-to-digital conversion signals ADCS corresponding to a specific number of initial symbols of the first received signal RSIG1 received from the external device of the first receiver RE1 (e.g., the second electronic device 1200 of FIG. 1). The first receiver RE1 may generate the feed forward equalization signals FFES by performing only step S245 on the analog-to-digital conversion signals corresponding to the symbols after the initial symbols. However, the present disclosure is not limited thereto, and the first receiver RE1 may perform steps S241 to S245 described above with respect to the analog-to-digital conversion signals ADCS corresponding to all symbols included in the first received signal RSIG1.

FIG. 11 is an example flowchart for describing step S244 of FIG. 10. Referring to FIGS. 4, 6, 10, and 11 in step S244a, the first receiver RE1 may increase the number of FFE masking bits. For example, the masking bit number determiner 142 may increase the number of FFE masking bits by one. For example, the current number of FFE masking bits may be m (where m is a natural number). In this case, the masking bit number determiner 142 may increase the number of FFE masking bits to m+1.

In step S244b, the first receiver RE1 may generate the feed forward equalization signals FFES based on the current number of FFE masking bits. For example, the feed forward equalization circuit 132 may receive the FFE masking bit control signal MBS_ffe including information on the current number of FFE masking bits. The feed forward equalization circuit 132 may generate the FFE masking signals by performing the masking operation on the FFE tap output signals in response to the FFE masking bit control signal MBS_ffe. The feed forward equalization circuit 132 may generate feed forward equalization signals FFES based on the FFE masking signals.

In step S244c, the first receiver RE1 may compare the target SNR SNR_tgt with the current SNR SNR_ffes of the feed forward equalization signals FFES. For example, the SNR monitor 141 may measure the SNR SNR_ffes of the current feed forward equalization signals FFES. The masking bit number determiner 142 may compare the SNR SNR_ffes of the current feed forward equalization signals FFES with the target SNR SNR_tgt. When the SNR SNR_ffes of the current feed forward equalization signals FFES is greater than the target SNR SNR_tgt, the first receiver RE1 may perform step S244a. When the SNR SNR_ffes of the current feed forward equalization signals FFES is less than or equal to the target SNR SNR_tgt, the first receiver RE1 may perform step S244d.

In step S244d, the first receiver RE1 may determine whether the SNR SNR_ffes of the current feed forward equalization signals FFES is equal to the target SNR SNR_tgt. When the SNR SNR_ffes of the current feed forward equalization signals FFES is equal to the target SNR SNR_tgt, the first receiver RE1 may determine the current number of FFE masking bits as a final number of FFE Masking bits. When the SNR SNR_ffes of the current feed forward equalization signals FFES is smaller than the target SNR SNR_tgt, the first receiver RE1 may perform step S244e.

In step S244e, the first receiver RE1 may determine a value reduced by 1 from the current number of FFE masking bits as the final number of FFE Masking bits. For example, the masking bit number determiner 142 may determine a value reduced by 1 from the current FFE masking bit number as the final FFE masking bit number. The masking bit number determiner 142 may output a masking bit control signal MBS_ffe including information on the final masking bit number. In this case, the SNR SNR_ffes of the feed forward equalization signals FFES generated based on the final number of masking bits may approximate the target SNR SNR_tgt. For example, the current number of FFE masking bits may be m (where m is a natural number). In this case, the masking bit number determiner 142 may determine the final number of FFE masking bits as (m−1).

As described above, the first receiver RE1 may repeatedly perform steps S244a to S244c until the SNR SNR_ffes of the feed forward equalization signals FFES is less than or equal to the target SNR SNR_tgt. Accordingly, the first receiver RE1 may determine the maximum value of the number of masking bits in the range in which the SNR SNR_ffes of the feed forward equalization signals FFES satisfies the target SNR SNR_tgt as the final number of masking bits. Accordingly, the ISI mitigation performance and power consumption of the FFE circuit 132 can be optimized.

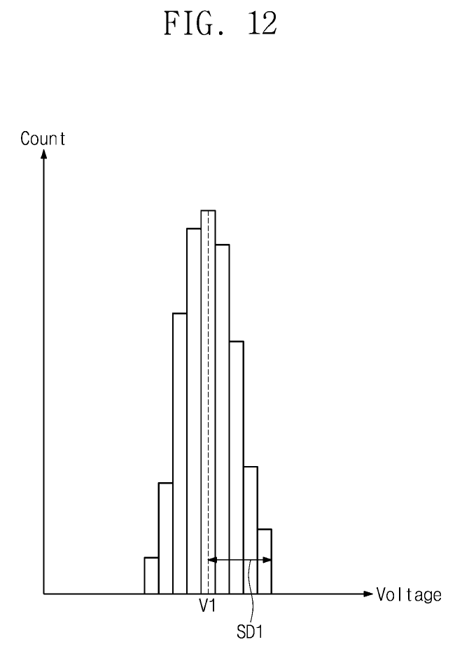

FIG. 12 is an example diagram for explaining step S243 of FIG. 10 and step S244c of FIG. 11. The graph of FIG. 12 shows histograms for the feed forward equalization signals FFES1 to FFESn. In the graph of FIG. 12, the horizontal axis indicates voltage and the vertical axis indicates frequency.

Referring to FIG. 12, histograms for the feed forward equalization signals FFES1 to FFESn corresponding to one symbol are distributed based on the first voltage V1 and may have a first standard deviation SD1. The magnitude of the first standard deviation SD1 may be determined based on the mitigation degree of the ISI. For example, the larger the degree of ISI mitigation by feed forward equalization, the smaller the magnitude of the first standard deviation SD1 may be. That is, the smaller the magnitude of the first standard deviation SD1, the larger the SNR of the feed forward equalization signals FFES.

In some implementations, the SNR monitor 141 may measure a standard deviation for the feed forward equalization signals FFES. The SNR monitor 141 may check the current SNR of the feed forward equalization signals FFES based on the measured standard deviation.

In some implementations, the masking bit number determiner 142 may determine the FFE masking bit number based on the SNR information (info_SNR). For example, the current SNR SNR_ffes of the feed forward equalization signals FFES may be greater than the target SNR SNR_tgt. In this case, the masking bit number determiner 142 may increase the number of FFE masking bits until the SNR of the feed forward equalization signals FFES becomes smaller than the target SNR.

In some implementations, the masking bit number determiner 142 may determine the maximum value of the number of FFE masking bits for which the current SNR of the feed forward equalization signals FFES satisfies the target SNR as the final number of FFE Masking bits.

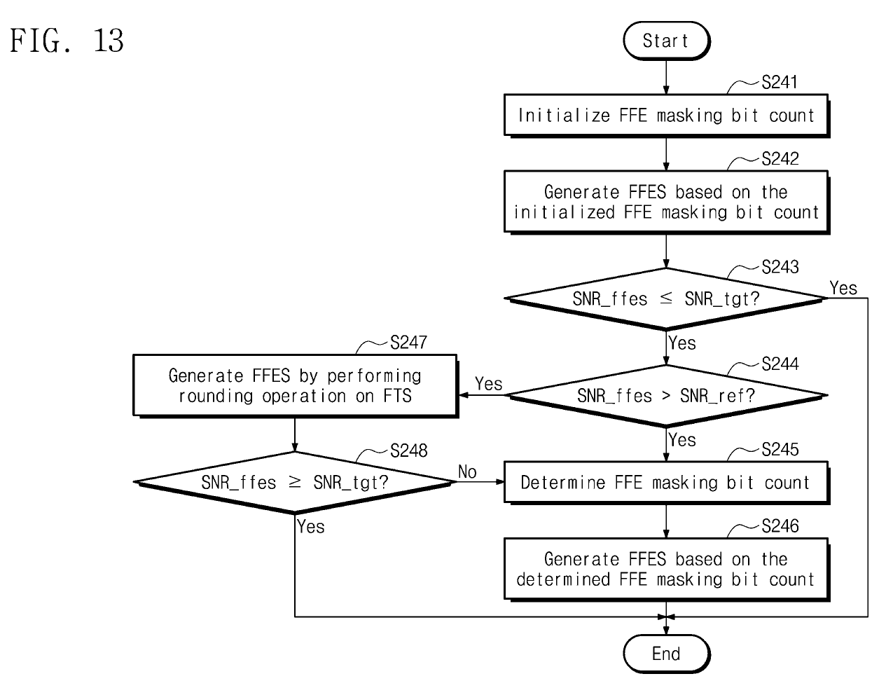

FIG. 13 is a flowchart for explaining an example of step S240 of FIG. 9. Steps S241, S242, S243, S245, and S246 of FIG. 13 correspond to steps S241, S242, S243, S244, and S245 of FIG. 10, respectively. Therefore, a detailed description of the above-described steps is omitted. In the following, the differences between FIG. 10 and FIG. 13 will be mainly described.

Referring to FIG. 13, in step S244, the first receiver RE1 may compare the reference SNR SNR_ref with the SNR SNR_ffes of the current feed forward equalization signals FFES. In some implementations, the reference SNR SNR_ref may be a value greater than the target SNR_tgt. When the SNR SNR_ffes of the current feed forward equalization signals FFES is greater than the reference SNR SNR_ref, the first receiver RE1 may perform step S247. When the SNR SNR_ffes of the current feed forward equalization signals FFES is less than or equal to the reference SNR SNR_ref, the first receiver RE1 may perform step S245. In some implementations, when the SNR SNR_ffes of the current feed forward equalization signals FFES is greater than the reference SNR SNR_ref, the masking bit number determiner 142 may output the FFE masking bit control signal MBS_ffe indicating the performance of the round up operation. As described with reference to FIG. 12, the masking bit number determiner 142 may confirm the SNR of the feed forward equalization signals FFES based on the standard deviation.

In step S247, the first receiver RE1 may perform a round up operation on the FFE tap output signals to generate the feed forward equalization signals FFES. For example, a feed forward equalizer (e.g., FFEk) may perform a round up operation on FFE tap output signals (e.g., FTSk−2 ̃FTSk+2) to generate FFE masking signals (e. g., FMSk−2 to FMSk+2). The feed forward equalizer (e.g., FFEk) may generate a feed forward equalization signal (e.g., FFESk) based on the FFE masking signals (e.g., FMSk−2 to FMSk+2).

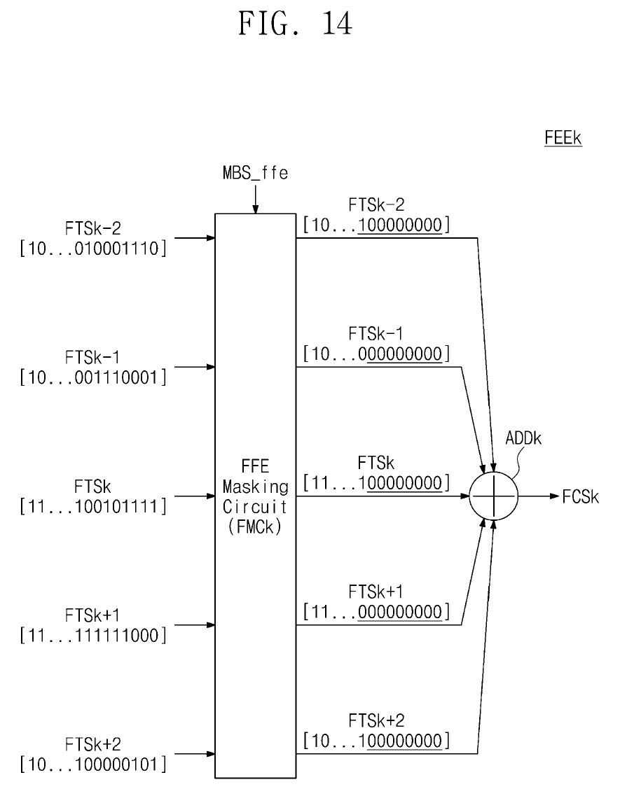

In some implementations, the round up operation of step S247 may be performed on a predetermined number of bits of the FFE tap output signal bits. For example, the predetermined number may be a number of bits constituting a fractional portion of the FFE tap output signal bits. However, the present disclosure is not limited thereto, and the predetermined number may be variously changed. The round up operation in step S247 is described in more detail with reference to FIG. 14.

When performing the round up operation on the FFE tap output signals (e.g., FTSk-2 to FTSk+2) to generate the FFE masking signals (e. g., FMSk-2 to FMSk+2), the number of bits having the logical value “0” included in the FFE masking signals (e.g., FMSg-2 to FMSg+2) may be greatly reduced without performing the operation of determining the number of masking bits. Accordingly, the computational complexity in the adder (e.g., ADDk) of the feed forward equalizer (e.g., FFEk) can be greatly reduced. Thus, power consumption of the feed forward equalizer (e.g., FFEk) can be greatly reduced.

In step S248, the first receiver RE1 may compare the current SNR SNR_ffes of the feed forward equalization signals FFES with the target SNR SNR_tgt. When the current SNR SNR_ffes is greater than or equal to the target SNR SNR_tgt, the first receiver RE1 may input the current feed forward equalization signals FFES to the decision feedback equalization circuit 133. When the current SNR SNR_ffes is smaller than the reference SNR SNR_ref, the first receiver RE1 may perform step S245.

As described above, the initial SNR of the feed forward equalization signals FFES may be excessively higher than the target SNR SNR_tgt. In this case, the first receiver RE1 may perform the round up operation to generate the feed forward equalization signals FFES. Accordingly, power consumption in a feed forward equalizer (e.g., FFEk) can be greatly reduced. That is, when the initial SNR of the feed forward equalization signals FFES is excessively high, the first receiver RE1 may perform the round up operation without performing an operation of determining the number of masking bits to quickly optimize the ISI mitigation performance and power consumption of the feed forward equalizer (e.g., FFEk).

FIG. 14 is an example diagram for explaining step S247 of FIG. 13. Referring to FIG. 14, in some implementations, when the current SNR SNR_ffes of the feed forward equalization signals FFES is greater than the reference SNR SNR_ref, the masking bit number determiner 142 may output the FFE masking bit control signal MBS_ffe indicating the performance of the round up operation on the predetermined number of bits. The FFE masking circuit FMCk may perform a round up operation on bits of the FFE tap output signals FTSk-2 to FTSk+2 in response to the FFE masking bit control signal MBS_ffe.

As shown in FIG. 14, for example, the (k−2)th FFE tap output signal FTSk−2 may be “10…010001110”, the (k−1)th FFE tap output signal FTSk−1 may be “10…01110001”, the kth FFE tap output signal FTSk may be “11…100101111”, the (k+1)th FFE tap output signal FTSk+1 may be “11…111111000”, and the (k+2)th FFE tap output signal FTSk+2 may be “10…100000101”. For example, the FFE tap output signals FTSk-2 to FTSk+2 may be digital values expressed in a fixed-point manner. In addition, the lower 8 bits of each of the FFE tap output signals FTSk-2 to FTSk+2 may constitute fractional bits.

For example, the FFE masking bit control signal MBS_ffe may indicate the performance of the round up operation on all the fractional bits of the FFE tap output signals FTSk-2 to FTSk+2 (that is, the predetermined number related to the round up operation may be eight). In this case, the FFE masking circuit FMCk may generate FFE masking signals FMSk-2 to FMSk+2 by performing the round up operation based on a bit value of each of the fractional bits of the FFE tap output signals FTSk-2 to FTSk+2. For example, the round up operation may include, when a logic value of a most significant bit of the fractional bits of the FFE tap output signal is “1”, performing round up operation with respect to the most significant bit, and adjusting the logic value of the remaining fractional bits to “0”. Further, the round up operation may include adjusting the logic value of all the fractional bits to “0” when the logic value of the most significant bit of the fractional bits of the FFE tap output signal is “0”.

Therefore, the (k−2)th FFE masking signal FMSk−2 may be “10… 100000000”, the (k−1)th FFE Masking signal FMSk−1 may be “10…000000000”, the kth FFE Masking signal FMSk may be “11…100000000”, the (k+1)th FFE masking signal FMSk+1 may be “11…0000000000”, and the (k+2)th FFE masking signal FMSk+2 may be “10…100000000”. As the FFE masking circuit FMCk performs the round up operation, the number of bits having the logic value “1” input to the adder ADDk may be greatly reduced. Accordingly, power consumption of the adder ADDk can be greatly reduced.

That is, when the current SNR of the feed forward equalization signals FFES is excessively larger than the target SNR, the FFE masking circuit FMCk may perform the round up operation on the FFE tap output signals FTSk-2 to FTSk+2. Accordingly, the FFE masking circuit FMCk may greatly reduce power consumption in the feed forward equalizer (e.g., FFEk).

FIG. 14 is described with reference to a case where the FFE masking circuit FMCk performs the round up operation on all the fractional bits of each of the FFE tap output signals FTSk-2 to FSTk+2, but the present disclosure is not limited thereto. For example, the FFE masking circuit FMCk may perform the round up operation on a predetermined number of lower bits among the fractional bits of each of the FFE tap output signals FTSk-2 to FSTk+2 in response to the FFE masking bit control signal MBS_ffe indicating performance of the round up operation.

Alternatively, in some implementations, the FFE masking circuit FMCk may perform the masking operation described with reference to FIGS. 8A to 8E for a predetermined specific number of masking bits instead of performing the raising operation described above. The specific number may be a number for greatly reducing the SNR (SNR_ffes) of the feed forward equalization signals FFES.

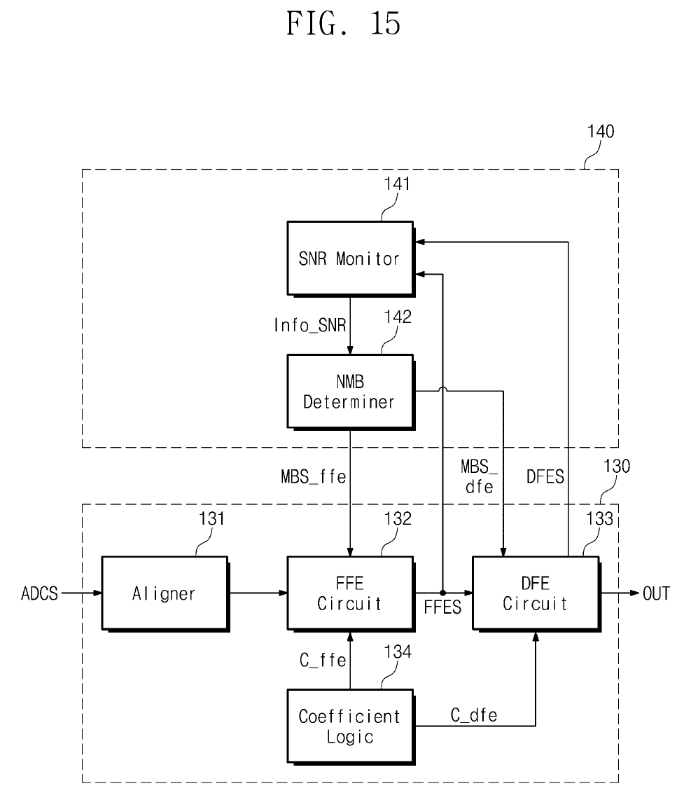

FIG. 15 is a block diagram illustrating an example of the equalizer circuit and the masking bit control circuit of FIG. 2. Referring to FIG. 15, the equalizer circuit 130 may include an aligner 131, a feed forward equalization circuit 132, a decision feedback equalization circuit 133, and a coefficient logic 134. The masking bit control circuit 140 may include an SNR monitor 141 and a masking bit number determiner 142. For ease of description, the differences between FIG. 15 and FIG. 2 are mainly described below.

Referring to FIG. 15, unlike the example of FIG. 2, the SNR monitor 141 may receive a decision feedback equalization signals DFES from the decision feedback equalization circuit 133. In this case, the equalization signal ES of FIG. 2 may include the decision feedback equalization signals DFES. The SNR monitor 141 may monitor the SNR of the decision feedback equalization signals DFES. The SNR monitor 141 may transmit the SNR information (info_SNR) to the masking bit number determiner 142. The SNR information info_SNR may include information on the SNR of the feed forward equalization signals FFES and information on the SNR of the decision feedback equalization signals DFES.

The masking bit number determiner 142 may determine a DFE masking bit number based on the SNR of the decision feedback equalization signals DFES. The masking bit number determiner 142 may determine the final number of DFE masking bits by increasing the number of DFE masking bits within a range in which the SNR of the decision feedback equalization signals DFES satisfies the target SNR. The masking bit number determiner 142 may output a DFE masking bit control signal MBS_dfe including information on the number of DFE masking bits. The masking bit control signal MBS of FIG. 2 may include the FFE masking bit control signals MBS_ffe and the DFE masking bit controls signal MBS_dfe.

The decision feedback equalization circuit 133 may receive the DFE masking bit control signal MBS_dfe. The decision feedback equalization circuit 133 may generate the output signal OUT by performing decision feedback equalization on the feed forward equalization signals FFES. In a process of performing decision feedback equalization, the decision feedback equalization circuit 133 may perform the masking operation based on the DFE masking bit control signal MBS_dfe. Accordingly, power consumption of the decision feedback equalization circuit 133 can be reduced. The decision feedback equalization circuit 133 will be described in more detail with reference to the following drawings.

That is, according to the implementation of FIG. 15, not only the feed forward equalization circuit 132 but also the decision feedback equalization circuit 133 may perform the masking operation. Accordingly, ISI mitigation performance and power consumption of the equalizer circuit 130 can be optimized.

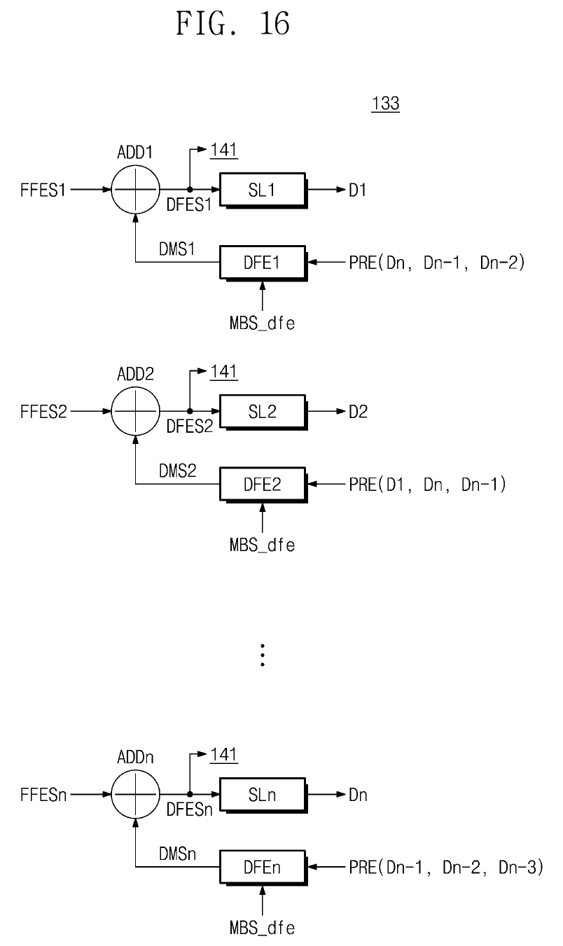

FIG. 16 is an example block diagram for describing the decision feedback equalization circuit of FIG. 15. Referring to FIG. 15, the decision feedback equalization circuit 133 may include a plurality of adders ADD1 to ADDn, a plurality of slicers SL1 to SLn, and a plurality of decision feedback equalizers DFE1 to DFEn.

Each of the plurality of adders ADD1 to ADDn may output the decision feedback equalization signals DFES1 to DFESn by adding the FFE masking signals FFES1 to FFESn and the DFE masking signals DMS1 to DMSn, respectively. The decision feedback equalization signals DFES1 to DFESn may be transmitted to the SNR monitor 141. The decision feedback equalization signals DFES1 to DFESn may be transmitted to the plurality of slicers SL1 to SLn, respectively.

The plurality of slicers SL1 to SLn may generate data values D1 to Dn based on the decision feedback equalization signals DFES1 to DFESn. For example, the first slicer SL1 may generate the first data value D1 based on the amplitude of the symbol included in the first decision feedback equalization signal DFES1, the second slicer SL2 may generate the second data value D2 based on the amplitudes of the symbols included in the second decision feedback equalization signals DFES2, and the n-th slicer SLn may generate the n-th data value Dn based on amplitudes of symbols included in the n-th decision feedback equalization signaling DFESn. For example, the output signal OUT may be generated based on a plurality of data values D1 to Dn.

The decision feedback equalizers DFE1 to EFEn may generate DFE masking signals DMS1 to DMSn based on the pre-signal PRE and the DFE masking bit control signal MBS_dfe, respectively. The pre-signal PRE may be data values generated prior to generation of the output data value. For example, the first decision feedback equalizer DFE1 may receive, as a pre-signal, the (n−2)th data value Dn−2, the (n−1)th data value Dn−1, and the nth data value Dn generated before generation of the first data value D1, the second decision feedback equalizer DFE2 may receive, as the pre-signal, the first data value D1, the nth data value Dn, and the (n−1)th data value Dn−1 generated before generation of a second data value D2, and the nth decision feedback equalizer DFEn may receive, as pre-signal PRE, the (n−1)th data value Dn−1, the (n−2)th data value Dn−2, and an (n−3)th Data value Dn−3 generated before generation of an nth data value Dn.

Each of the decision feedback equalizers DFE1 to DFEn may generate DFE tap output signals by applying a DFE coefficient corresponding to each of the data values of the pre-signal PRE. Each of the decision feedback equalizers DFE1 to EFEn may generate a DFE masking signal by performing the masking operation on the DFE tap output signals based on the DFE masking bit control signal MBS_dfe. In some implementations, the masking operation may be an operation of adjusting a bit value of lower bits corresponding to the number of DFE masking bits among bits of each of the DFE tap output signals (i.e., an operation of adjusting the digital value of each of the DFE tap output signals), as described with reference to FIGS. 8A to 8E.

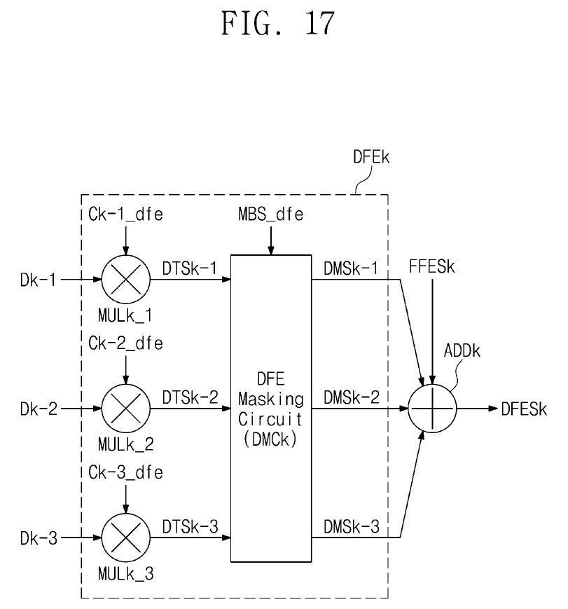

FIG. 17 is an example diagram for describing the decision feedback equalizer of FIG. 16. FIG. 17 illustrates kth decision feedback equalizer DFEk (k is a natural number smaller than n) among the decision feedback equalizers DFE1 to DFEn of FIG. 16. The decision feedback equalizers DFE1 to DFEn of FIG. 16 may be implemented in the same structure as the kth decision feedback equalizer DFEk of FIG. 17. Referring to FIG. 17, the kth decision feedback equalizer DFEk may generate the kth decision feedback equalization signal DFESk based on the data values Dk-1 to Dk-3. The kth decision feedback equalizer DFEk may include a plurality of multipliers MULk_1 to MULk_3, a DFE masking circuit DMCk, and an adder ADDk.

The plurality of multipliers MULk_1 to MULk_3 may respectively apply the decision feedback equalization coefficients Ck-1_dfe to Ck-3_dfe in the data values Dk-1 to Dk-3. Specifically, the first multiplier MULk_1 may output a (k−1)th DFE tap output signal DTSk−1 by multiplying the (k−1)th digital value Dk−1 by the (k−1)th decision feedback equalization coefficient Ck−1_dfe. The second multiplier MULk_2 may output a (k−2)th DFE tap output signal DTSk−2 by multiplying the (k−2)th digital value Dk−2 by the (k−2)th decision feedback equalization coefficient Ck−2_dfe. The third multiplier MULk_3 may output a (k−3)th DFE tap output signal DTSk−3 by multiplying the (k−3)th digital value Dk−3 by the (k−3)th decision feedback equalization coefficient Ck−2_dfe.

The DFE masking circuit DMCk may perform the masking operation on the DFE tap output signals DTSk-1 to DTSk-3 based on the DFE masking bit control signal MBS_ffe received from the masking bit number determiner 142. The DFE masking circuit DMCk may perform the masking operation to adjust digital values of the DFE tap output signals DTSk-1 to DTSk-3. The DFE masking circuit DMCk may output digital value-adjusted signals to the DFE masking signals DMSk-1 to DMSk-2.

In some implementations, the DFE masking bit control signal MBS_dfe may include information about the number of DFE masking bits. For example, the DFE masking number may be m (m is a natural number). In this case, in some implementations, the masking operation may be an operation of adjusting the logic value of the lowest m bits corresponding to the number of DFE masking bits among the bits of the DFE tap output signal to “0” similarly to the masking operation described in FIG. 8A.

However, the present disclosure is not limited thereto, and the masking operation may be similar to the masking operation described in FIG. 8B and FIG. 8E. Specifically, the masking operation may be an operation of determining the lowest m bits corresponding to the number of DFE masking bits among the bits of the DFE tap output signal as masking data, and generating the DFE masking signal based on a round up operation on the most significant bit of the masking data.

The DFE masking circuit DMCk may generate the DFE masking signals DMSk-1 to FMSk-3 by performing the masking operation on each of the DFE tap output signals DTSk-1 to DTSk-3. The DFE masking signals DMSk-1 to DMSk-3 may be input to the adder ADDk.

The adder ADDk may perform an addition operation on the DFE masking signals DMSk-1 to DMSk-3 and the kth feed-forward equalization signal FFESk to output the kth decision feedback equalization signal DFESk. Due to the masking operation, the number of bits having the logic value “1” included in the DFE masking signals DMSk-1 to DMSk-3 may be smaller than the number of bits having the logic value "1" included in the DFE tap output signals DTSk-1 to DTSk-3. Accordingly, the computational complexity in the adder ADDk may decrease as the masking operation is performed. Accordingly, power consumption in the adder ADDk may be reduced compared to a case where an addition operation based on the DFE tap output signals DTSk-1 to DTSk-3 is performed.

On the other hand, the number of DFE masking bits may be determined in a manner similar to that described with reference to FIGS. 10 to 12. In some implementations, the masking bit number determiner 142 may sequentially increase the number of DFE masking bits until the SNR of the decision feedback equalization signals DFES becomes smaller than or equal to the target SNR SNR_tgt. The masking bit number determiner 142 may determine the maximum value of the number of DFE masking bits for which the SNR of the decision feedback equalization signals DFES satisfies the target SNR (SNR_tgt) as the final number of DFE Masking bits. The first receiver RE1 may perform the masking operation on the DFE tap output signals based on the determined final number of DFE masking bits to reduce power consumption in the decision feedback equalization circuit 133. Accordingly, the ISI mitigation performance and power consumption of the decision feedback equalization circuit 133 can be optimized.

FIG. 17 illustrates the kth decision feedback equalizer DFEk having a 3-tap structure, but the present disclosure is not limited thereto, and the number of taps of each of the decision forward equalizers DFE1 to DFEn may be variously changed.

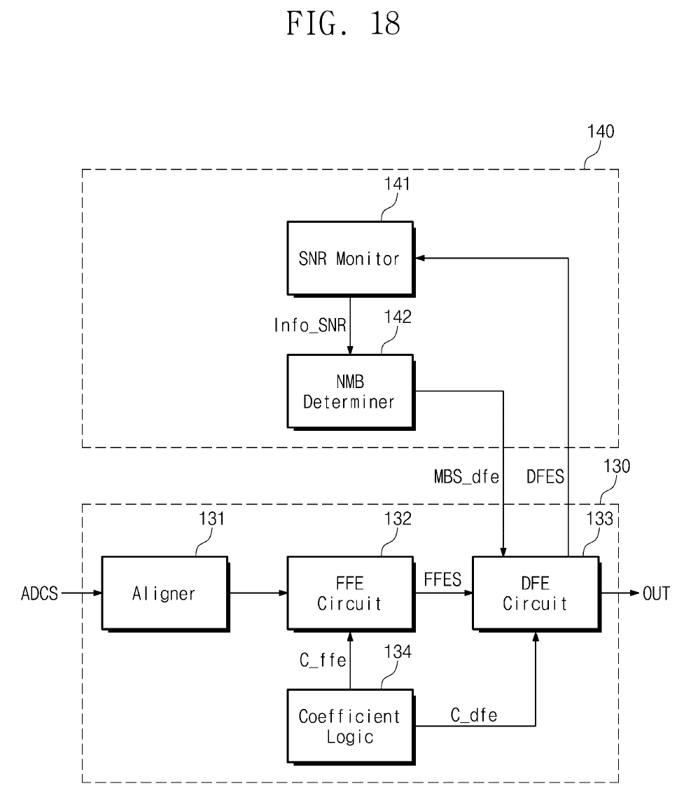

FIG. 18 is a block diagram illustrating an example of the equalizer circuit and the masking bit control circuit of FIG. 2. Referring to FIG. 18, the equalizer circuit 130 may include an aligner 131, a feed forward equalization circuit 132, a decision feedback equalization circuit 133, and a coefficient logic 134. The masking bit control circuit 140 may include an SNR monitor 141 and a masking bit number determiner 142. For ease of description, the differences between FIG. 18 and FIG. 15 are mainly described below.

Unlike the implementation of FIG. 15, referring to FIG. 18, in some implementations, the masking bit number determiner 142 may generate only the DFE masking bit control signal MBS_dfe. In this case, the masking operation may be performed only during the decision feedback equalization.

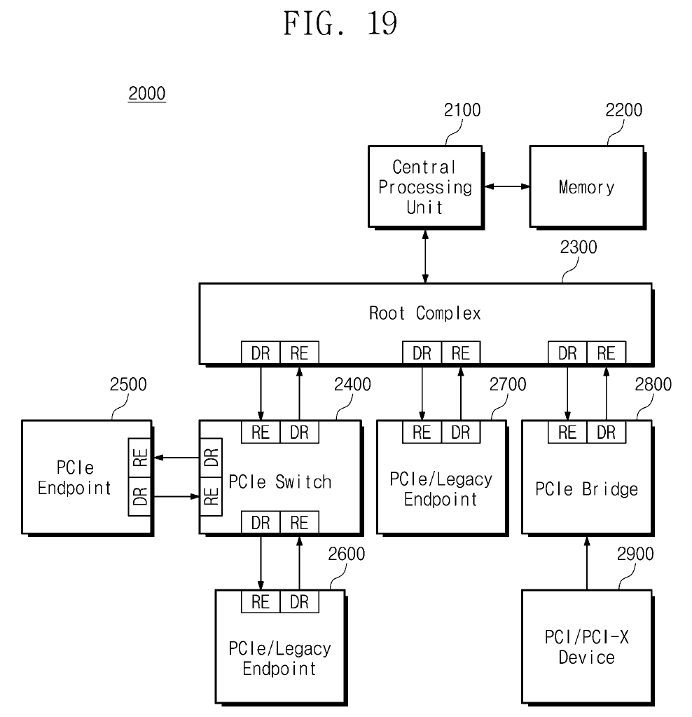

FIG. 19 is a block diagram illustrating an example of a system. Referring to FIG. 19, the system 2000 may include a central processing unit 2100, memory 2200, root complex 2300, PCIe switch 2400, PCIe endpoint 2500, legacy endpoint 2600, PCIe/legacy endpoint 2700, PCIe bridge 2800, and PCI/PCI-X device 2900. The PCI may be abbreviated as ‘Peripheral Component Interconnect’. The PCIe may be abbreviated ‘Peripheral Component Interconnect express’.

The central processing unit 2100 may execute an operating system and applications of the system 2000. The central processing unit 2100 may load and execute codes of the operating system and applications into the memory 2200. The central processing unit 2100 may store various data generated and used in the process of operating the system 2000 in the memory 2200.

The memory 2200 may be a system memory including a dynamic random-access memory (DRAM), a storage class memory (SCM), and the like. The memory 2200 may be implemented as a DIMM (Dual In-line Memory Module), a RDIMM (Registered DIMM), a LRDIMM (Load Reduced DIMM), an NVDIMM (NonVolatile DIMM), or the like.

The root complex 2300 may communicate with components of the system 2000 under the control of the central processing unit 2100. The root complex 2300 may operate based on the PCIe. The root complex 2300 may include PCIe drivers DR for transmitting analog signals to external electronic devices, and PCIe receivers RE for receiving analog signals from external electronic devices.

The PCIe switch 2400 may mediate communications between the root complex 2300 and other PCIe-based electronic devices (e.g., PCIe endpoint 2500 and legacy endpoint 2600). The PCIe switch 2400 may include PCIe drivers DR for transmitting analog signals to external electronic devices, and PCIe receivers RE for receiving analog signals from external electronic devices.

The PCIe endpoint 2500 or legacy endpoint 2600 may communicate with the root complex 2300 via the PCIe switch 2400. The PCIe endpoint 2500 or legacy endpoint 2600 may include various peripheral devices such as a digital signal processor, a hardware accelerator such as a graphics processing neural processor, a storage device such as a hard disk drive or a solid-state drive, and the like. The PCIe endpoint 2500 or legacy endpoint 2600 may include a PCIe driver DR for transmitting analog signals to external electronic devices, and a PCIe receiver RE for receiving analog signals from the external electronic devices.

The PCIe/legacy endpoint 2700 may include a PCIe endpoint or a legacy endpoint. The PCIe/legacy endpoint 2700 may include a PCIe driver DR for transmitting analog signals to an external electronic device, and a PCIe receiver RE for receiving analog signals from the external electronic device.

The PCIe bridge 2800 may mediate communication between the PCI/PCI-X device and the root complex 2300. The PCIe bridge 2800 may include a PCIe driver DR for transmitting analog signals to an external electronic device, and a PCIe receiver RE for receiving analog signals from the external electronic device. The PCI/PCI-X device 2900 may communicate with the root complex 2300 via the PCIe bridge 2800.

The receiver RE of the PCIe-based electronic device (e.g., 2300, 2400, 2500, 2600, 2700, or 2800) described with reference to FIG. 19 may correspond to the first receiver RE1 of FIG. 2. That is, the receiver RE may perform feed forward equalization based on the masking operation. Alternatively, the receiver RE may perform feed forward equalization and decision feedback equalization based on the masking operation. Alternatively, the receiver RE may perform decision feedback equalization based on the masking operation.

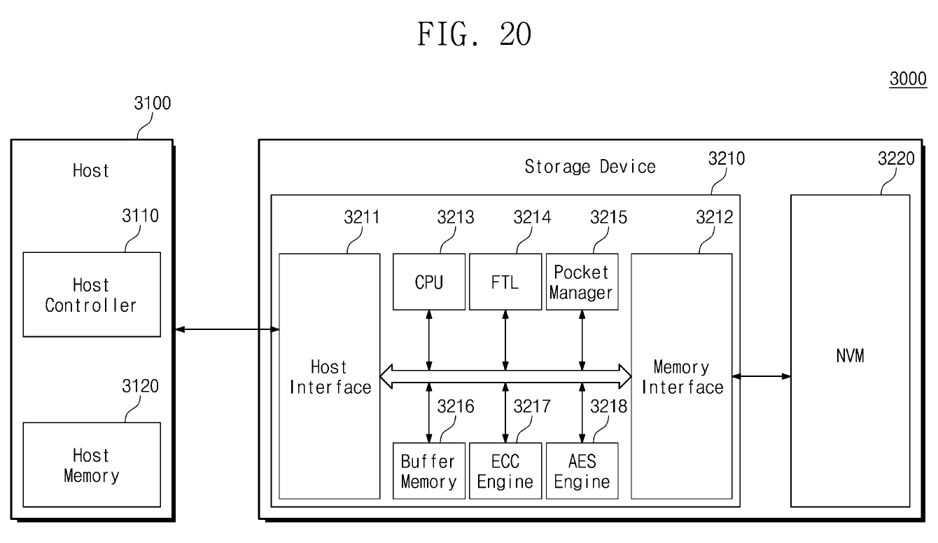

FIG. 20 is a block diagram of an example of a host storage system 10. The host storage system 10 may include a host 3100 and a storage device 3200. Further, the storage device 3200 may include a storage controller 3210 and an NVM 3220. According to an example implementation, the host 3100 may include a host controller 3110 and a host memory 3120. The host memory 3120 may serve as a buffer memory configured to temporarily store data to be transmitted to the storage device 3200 or data received from the storage device 3200.

In one implementation, communication between the host 3100 and the storage device 3200 may be performed in the manner described with reference to FIGS. 1-18. For example, the host 3100 may correspond to the second electronic device 1200 of FIG. 1, the storage device 3200 may correspond to the first electronic device 1100 of FIG. 1, and the host interface 3211 may correspond to the first communication module 1130 of FIG. 1.

The storage device 3200 may include storage media configured to store data in response to requests from the host 100. As an example, the storage device 3200 may include at least one of an SSD, an embedded memory, and a removable external memory. When the storage device 3200 is an SSD, the storage device 3200 may be a device that conforms to an NVMe standard. When the storage device 3200 is an embedded memory or an external memory, the storage device 3200 may be a device that conforms to a UFS standard or an eMMC standard. Each of the host 3100 and the storage device 3200 may generate a packet according to an adopted standard protocol and transmit the packet.

When the NVM 3220 of the storage device 3200 includes a flash memory, the flash memory may include a 2D NAND memory array or a 3D (or vertical) NAND (VNAND) memory array. As another example, the storage device 3200 may include various other kinds of NVMs. For example, the storage device 3200 may include magnetic RAM (MRAM), spin-transfer torque MRAM, conductive bridging RAM (CBRAM), ferroelectric RAM (FRAM), PRAM, RRAM, and various other kinds of memories.

According to some implementations, the host controller 3110 and the host memory 3120 may be implemented as separate semiconductor chips. Alternatively, in some implementations, the host controller 3110 and the host memory 3120 may be integrated in the same semiconductor chip. As an example, the host controller 3110 may be any one of a plurality of modules included in an application processor (AP). The AP may be implemented as a System on Chip (SoC). Further, the host memory 3120 may be an embedded memory included in the AP or an NVM or memory module located outside the AP.

The host controller 3110 may manage an operation of storing data (e.g., write data) of a buffer region of the host memory 3120 in the NVM 3220 or an operation of storing data (e.g., read data) of the NVM 3220 in the buffer region.

The storage controller 3210 may include a host interface 3211, a memory interface 3212, and a CPU 3213. Further, the storage controllers 3210 may further include a flash translation layer (FTL) 3214, a packet manager 3215, a buffer memory 3216, an error correction code (ECC) engine 3217, and an advanced encryption standard (AES) engine 3218. The storage controllers 3210 may further include a working memory in which the FTL 3214 is loaded. The CPU 3213 may execute the FTL 3214 to control data write and read operations on the NVM 3220.

The host interface 3211 may transmit and receive packets to and from the host 3100. A packet transmitted from the host 3100 to the host interface 3211 may include a command or data to be written to the NVM 3220. A packet transmitted from the host interface 3211 to the host 3100 may include a response to the command or data read from the NVM 3220. The memory interface 3212 may transmit data to be written to the NVM 3220 to the NVM 3220 or receive data read from the NVM 3220. The memory interface 3212 may be configured to comply with a standard protocol, such as Toggle or open NAND flash interface (ONFI).

The FTL 3214 may perform various functions, such as an address mapping operation, a wear-leveling operation, and a garbage collection operation. The address mapping operation may be an operation of converting a logical address received from the host 3100 into a physical address used to actually store data in the NVM 3220. The wear-leveling operation may be a technique for preventing excessive deterioration of a specific block by allowing blocks of the NVM 3220 to be uniformly used. As an example, the wear-leveling operation may be implemented using a firmware technique that balances erase counts of physical blocks. The garbage collection operation may be a technique for ensuring usable capacity in the NVM 3220 by erasing an existing block after copying valid data of the existing block to a new block.

The packet manager 3215 may generate a packet according to a protocol of an interface, which consents to the host 3100, or parse various types of information from the packet received from the host 3100. In addition, the buffer memory 3216 may temporarily store data to be written to the NVM 3220 or data to be read from the NVM 3220. Although the buffer memory 3216 may be a component included in the storage controllers 3210, the buffer memory 3216 may be outside the storage controllers 3210.

The ECC engine 3217 may perform error detection and correction operations on read data read from the NVM 3220. More specifically, the ECC engine 3217 may generate parity bits for write data to be written to the NVM 3220, and the generated parity bits may be stored in the NVM 3220 together with write data. During the reading of data from the NVM 3220, the ECC engine 3217 may correct an error in the read data by using the parity bits read from the NVM 3220 along with the read data, and output error-corrected read data.

The AES engine 3218 may perform at least one of an encryption operation and a decryption operation on data input to the storage controllers 3210 by using a symmetric-key algorithm.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The above description refers to detailed implementations for carrying out the present disclosure. The present disclosure may include implementations in which a design is changed simply or which are easily changed, as well as some implementations described above. In addition, technologies that are easily changed and implemented by using the above implementations may be included in the present disclosure. While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. A signal receiver comprising:
an analog front-end circuit configured to perform an amplification operation on a signal to generate an amplified signal;
an analog-to-digital conversion circuit configured to perform digital sampling on the amplified signal to generate a plurality of analog-to-digital conversion signals;
a feed forward equalization circuit comprising a plurality of feed forward equalizers, the plurality of feed forward equalizers being configured to perform feed forward equalization on the plurality of analog-to-digital conversion signals to generate a plurality of feed forward equalization signals; and
a masking bit control circuit configured to generate a first masking bit control signal associated with the feed forward equalization,
wherein the plurality of feed forward equalizers includes a first feed forward equalizer configured to
generate a plurality of first tap output signals based on a plurality of first analog-to-digital conversion signals among the plurality of analog-to-digital conversion signals,
adjust a digital value of each first tap output signal of the plurality of first tap output signals based on the first masking bit control signal to generate a plurality of first masking signals, and
generate a first feed forward equalization signal of the plurality of feed forward equalization signals based on the plurality of first masking signals.

2. The signal receiver of claim 1,
wherein a number of bits having a first logic value in the plurality of first masking signals is less than a number of bits having the first logic value in the plurality of first tap output signals.

3. The signal receiver of claim 1, wherein the first feed forward equalizer includes:
a plurality of multipliers configured to generate the plurality of first tap output signals by respectively applying a plurality of feed forward equalization coefficients to the plurality of first analog-to-digital conversion signals;
a first masking circuit configured, based on the first masking bit control signal, to adjust a logic value of bits corresponding to a first number of masking bits among bits of the plurality of first tap output signals to generate the plurality of first masking signals;
a first adder configured to perform a first addition operation on the plurality of first masking signals to generate a first computation signal; and
a shifting circuit configured to adjust a number of bits of the first computation signal to generate a first feed forward equalization signal.

4. The signal receiver of claim 3, wherein the first number of masking bits is k wherein k is a natural number, and
wherein the first masking circuit is configured to adjust a logic value of a lowest k bits of each first tap output signal of the plurality of first tap output signals to adjust the digital value of each first tap output signal of the plurality of the first tap output signals.

5. The signal receiver of claim 4, wherein the first masking circuit is configured to adjust the logic value of each of the lowest k bits to 0 to adjust the digital value of each first tap output signal of the plurality of first tap output signals.

6. The signal receiver of claim 4, wherein:
the first masking circuit is configured to:
perform, based on a logical value of a most significant bit among the lowest k bits being 1, a round up operation on the most significant bit among the lowest k bits, and adjust the logical value of each bit except the most significant bit among the lowest k bits to 0, and
adjust, based on the logical value of the most significant bit being 0, the logic value of each of the lowest k bits to 0.

7. The signal receiver of claim 3, wherein the masking bit control circuit includes:
a signal-to-noise ratio (SNR) monitor configured to measure an SNR of the plurality of feed forward equalization signals and to output first SNR information; and
a masking bit number determiner configured to determine a first masking bit number based on the first SNR information and to generate the first masking bit control signal including information about the first masking bit number.

8. The signal receiver of claim 7, comprising a decision feedback equalization circuit configured to perform decision feedback equalization on the plurality of feed forward equalization signals to generate a plurality of decision feedback equalization signals and a plurality of data values,
wherein the decision feedback equalization circuit includes:
a first decision feedback equalizer configured to generate a plurality of second tap output signals by respectively applying decision feedback equalization coefficients to a plurality of first pre-signals, and to adjust a digital value of each of the plurality of second tap output signals to generate a plurality of second masking signals;
a second adder configured to perform a second addition operation on the first feed forward equalization signal and the plurality of second masking signals to generate a first decision feedback equalization signal of the plurality of decision feedback equalization signals; and
a slicer configured to determine data corresponding to the first decision feedback equalization signal to generate a first data value of the plurality of data values.

9. The signal receiver of claim 8, wherein the masking bit control circuit is configured to generate a second masking bit control signal associated with the decision feedback equalization, and
wherein the first decision feedback equalizer includes a second masking circuit configured to generate, based on the second masking bit control signal, the plurality of second masking signals by adjusting logic values of bits corresponding to a second number of masking bits among bits of the plurality of second tap output signals.

10. The signal receiver of claim 9, wherein the SNR monitor is configured to measure an SNR of the plurality of decision feedback equalization signals to generate a second information, and
wherein the masking bit number determiner is configured to determine the second number of masking bits based on the second information.

11. The signal receiver of claim 9, wherein the second number of masking bits is m wherein m is a natural number, and
wherein the second masking circuit is configured to adjust the digital value of each of the plurality of second tap output signals by adjusting a logic value of a lowest m bits of each second tap output signal of the plurality of second tap output signals.

12. The signal receiver of claim 11,
wherein the second masking circuit is configured to adjust a logic value of each of the lowest m bits to 0 to adjust the digital value of each of the plurality of second tap output signals.

13. A method of operating a signal receiver comprising a masking bit control circuit and an equalizer circuit, the method comprising:
generating, by the equalizer circuit, a plurality of tap output signals by applying feed forward equalization coefficients, the feed forward equalization coefficients respectively corresponding to a plurality of digital signals;
adjusting, by the equalizer circuit, a logic value of at least one bit of the plurality of tap output signals based on a masking bit control signal to generate a plurality of masking signals;
performing, by the equalizer circuit, an addition operation on the plurality of masking signals to generate a plurality of computation signals; and
generating, by the equalizer circuit, a plurality of feed forward equalization signals based on the plurality of computation signals.

14. The method of claim 13, comprising:
initializing, by the masking bit control circuit, a masking bit number; and
generating, by the equalizer circuit, a first feed forward equalization signal based on the masking bit number.

15. The method of claim 14, comprising:
increasing, by the masking bit control circuit, the masking bit number by 1 based on a signal-to-noise ratio (SNR) of the first feed forward equalization signal being greater than a target SNR;
generating, by the equalizer circuit, a second feed forward equalization signal based on the masking bit number;
based on an SNR of the second feed forward equalization signal being less than the target SNR, decreasing, by the masking bit control circuit, the masking bit number by 1 as a final masking bit number; and
generating, by the masking bit control circuit, the masking bit control signal including information about the final masking bit number.

16. The method of claim 13, wherein:
the masking bit control signal indicates that a number of masking bits is k wherein k is a natural number, and
wherein generating the plurality of masking signals comprises:
adjusting, by the equalizer circuit, a logic value of a lowest k bits of each tap output signal of the plurality of tap output signals to a first value.

17. The method of claim 16, wherein the first value is 0.

18. The method of claim 13, wherein generating the plurality of feed forward equalization signals comprises:
performing, for each computation signal of the plurality of computation signals, a shifting operation that excludes fractional bits to generate the plurality of feed forward equalization signals.

19. An electronic system comprising a first electronic device and a second electronic device, wherein:
the first electronic device is configured to communicate with the second electronic device, and includes a communication module including a transmitter and a receiver,
wherein the receiver comprises:
an analog front-end circuit configured to perform an amplification operation on a signal to generate an amplified signal;
an analog to digital conversion circuit configured to perform digital sampling on the amplified signal to generate a plurality of analog-to-digital conversion signals;
a feed forward equalizer circuit configured to perform feed forward equalization (FFE) on the plurality of analog-to-digital conversion signals to generate a plurality of feed forward equalization signals; and
a masking bit control circuit configured to generate a masking bit control signal based on the plurality of feed forward equalization signals, the masking bit control signal including information about a number of masking bits,
wherein the feed forward equalizer circuit includes a first feed forward equalizer configured to generate a first feed forward equalization signal of the plurality of feed forward equalization signals based on a plurality of first digital signals among a plurality of digital signals, and
wherein the first feed forward equalizer includes:
a plurality of multipliers configured to generate a plurality of first tap output signals based on the plurality of first digital signals and a plurality of feed forward equalization coefficients respectively corresponding to the plurality of first digital signals;
a first masking circuit configured to adjust a digital value of each first tap output signal of the plurality of first tap output signals based on the number of masking bits to generate a plurality of first masking signals; and
a first adder configured to perform an addition operation on the plurality of first masking signals to generate a first computation signal.

20. The electronic system of claim 19, wherein the masking bit control circuit includes:
a signal-to-noise ratio (SNR) monitor configured to measure an SNR of the plurality of feed forward equalization signals and to output a first SNR information; and
a masking bit number determiner configured to determine a first masking bit number based on the first SNR information.
